(19) United States
(12) Patent Application Publication
(10) Pub. No.: US 2025/0048327 A1
(43) Pub. Date: Feb. 6, 2025

(54) RAT-INDEPENDENT POSITIONING IN SIDELINK

(71) Applicant: Lenovo (Singapore) Pte. Ltd., New Tech Park (SG)

(72) Inventors: Robin Rajan Thomas, Bad Nauheim (DE); Karthikeyan Ganesan, Kronberg im Taunus (DE); Abir Ben Hadj Fredj, Frankfurt am main (DE)

(21) Appl. No.: 18/717,307

(22) PCT Filed: Dec. 7, 2022
(86) PCT No.: PCT/IB2022/061894

§ 371 Date: Jun. 6, 2024

Related U.S. Application Data
(60) Provisional application No. 63/286,859, filed on Dec. 7, 2021.

(51) Int. Cl. H04W 64/00; G01S 19/25; H04W 72/25

(52) U.S. Cl. CPC H04W 64/003; G01S 19/252; H04W 72/25

(57) ABSTRACT

Apparatuses, methods, and systems are disclosed for RAT-independent positioning in sidelink. An apparatus (1500) includes a memory and a processor (1505) coupled to the memory (1510). The processor (1505) transmits, to at least one other device via an SL connection, a RAT-independent positioning information configuration and a RAT-independent reporting configuration. The processor (1505) receives a RAT-independent measurement and location report in response to the RAT-independent positioning information and reporting configuration. The processor (1505) detects an error related to a SL positioning assistance data configuration, measurement, and information report. The processor (1505) transmits an indication of the error and a request for supported RAT-independent positioning capabilities of the at least one other device. The processor (1505) receives a response comprising the supported RAT-independent positioning capabilities of the at least one other device.

### CROSS-REFERENCE TO RELATED APPLICATIONS

This application claims priority to U.S. Patent Application Ser. No. 63/286,859 entitled “APPARATUSES, METHODS, AND SYSTEMS FOR RAT-INDEPENDENT POSITIONING IN SIDELINK” and filed on Dec. 7, 2021, for Robin Thomas, et al., which is incorporated herein by reference in its entirety.

### FIELD

The subject matter disclosed herein relates generally to wireless communications and more particularly relates to radio access technology (“RAT”)-independent positioning in sidelink.

### BACKGROUND

In wireless networks, although there exists a third generation partnership project (“3GPP”) positioning framework, which enables user equipment (“UE”)-assisted and UE-based positioning methods, there is currently a lack of support for efficient UE-to-UE range/orientation determination, which is essential to support relative positioning applications across different vertical services, e.g., V2X, Public Safety, industrial internet of things (“IIoT”), commercial, or the like.

### BRIEF SUMMARY

Disclosed are solutions for RAT-independent positioning in sidelink. The solutions may be implemented by apparatus, systems, methods, or computer program products.

In one embodiment, a first apparatus includes a memory and a processor coupled to the memory. The processor, in one embodiment, is configured to cause the apparatus to transmit, to at least one other device via an SL connection, a RAT-independent positioning information configuration and a RAT-independent reporting configuration. In one embodiment, the processor is configured to cause the apparatus to receive, from the at least one other device via the SL connection, a RAT-independent measurement and location report in response to the RAT-independent positioning information and reporting configuration. In one embodiment, the processor is configured to cause the apparatus to detect an error related to a SL positioning assistance data configuration, measurement, and information report. In one embodiment, the processor is configured to cause the apparatus to transmit, to the at least one other device via the SL connection, an indication of the error and a request for supported RAT-independent positioning capabilities of the at least one other device. In one embodiment, the processor is configured to cause the apparatus to receive, from the at least one other device via the SL connection, a response comprising the supported RAT-independent positioning capabilities of the at least one other device.

A first method, in one embodiment, transmits, to at least one other device via an SL connection, a RAT-independent positioning information configuration and a RAT-independent reporting configuration. In one embodiment, the first method receives, from the at least one other device via the SL connection, a RAT-independent measurement and location report in response to the RAT-independent positioning information and reporting configuration. In one embodiment, the first method detects an error related to a SL positioning assistance data configuration, measurement, and information report. In one embodiment, the first method transmits, to the at least one other device via the SL connection, an indication of the error and a request for supported RAT-independent positioning capabilities of the at least one other device. In one embodiment, the first method receives, from the at least one other device via the SL connection, a response comprising the supported RAT-independent positioning capabilities of the at least one other device.

In one embodiment, a second apparatus includes a memory and a processor coupled to the memory. In one embodiment, the processor is configured to cause the apparatus to receive, from an initiator device via a SL connection, a RAT-independent positioning information configuration and a RAT-independent reporting configuration. In one embodiment, the processor is configured to cause the apparatus to transmit, to the initiator device via the SL connection, a RAT-independent measurement and location report in response to the RAT-independent positioning information and reporting configuration. In one embodiment, the processor is configured to cause the apparatus to detect an error related to a SL positioning assistance data configuration, measurement, and information report. In one embodiment, the processor is configured to cause the apparatus to transmit, to the initiator device via the SL connection, an indication of the error and a response comprising supported RAT-independent positioning capabilities of the apparatus.

In one embodiment, a second method receives, from an initiator device via a SL connection, a RAT-independent positioning information configuration and a RAT-independent reporting configuration. In one embodiment, the second method transmits, to the initiator device via the SL connection, a RAT-independent measurement and location report in response to the RAT-independent positioning information and reporting configuration. In one embodiment, the second method detects an error related to a SL positioning assistance data configuration, measurement, and information report. In one embodiment, the second method transmits, to the initiator device via the SL connection, an indication of the error and a response comprising supported RAT-independent positioning capabilities.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for RAT-independent positioning in sidelink;

FIG. 2 depicts an example embodiment of an NR protocol stack:

FIG. 3 is an overview of absolute and relative positioning as defined in Stage 1 specifications:

FIG. 4 illustrates a Multi-Cell RTT Procedure:

FIG. 5 illustrates a relative range estimation using the existing single gNB RTT positioning framework:

FIG. 6 illustrates NR Beam-based Positioning:

FIG. 7A illustrates an A-GNSS Assistance Data:

FIG. 7B illustrates a WLAN Assistance Data:

FIG. 7C illustrates an A-GNSS Measurement Report:

FIG. 7D illustrates a WLAN Measurement Report:

FIG. 8 illustrates an SL Unicast A-GNSS Configuration:

FIG. 9 illustrates an SL Groupcast A-GNSS Configuration:

FIG. 10 illustrates a solicited unicast request and response signaling for A-GNSS configuration;

FIG. 11 illustrates a solicited request and response signaling for A-GNSS configuration in a groupcast scenario:

FIG. 12 illustrates SL RAT-independent positioning capability exchange procedures:

FIG. 13 illustrates an SL Unicast Error Indication:

FIG. 14 illustrates an SL Groupcast error indication:

FIG. 15 is a block diagram illustrating one embodiment of a user equipment apparatus that may be used for RAT-independent positioning in sidelink:

FIG. 16 is a block diagram illustrating one embodiment of a network apparatus that may be used for RAT-independent positioning in sidelink:

FIG. 17 is a flowchart diagram illustrating one embodiment of a method for RAT-independent positioning in sidelink; and

FIG. 18 is a flowchart diagram illustrating one embodiment of another method for RAT-independent positioning in sidelink.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising.” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for RAT-independent positioning in sidelink. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Although there exists a 3GPP positioning framework, which enables UE-assisted and UE-based positioning methods, there is currently a lack of support for efficient UE-to-UE range/orientation determination, which is essential to support relative positioning applications across different vertical services, e.g., V2X, Public Safety, IIoT, Commercial, or the like.

3GPP has also supported different positioning technologies including RAT-dependent and RAT-independent positioning methods, which enables different positioning technologies to be used in a complementary fashion to determine and improve the target-UE's location estimate. Currently, RAT-independent positioning has been enabled for the Uu (uplink and downlink), however, the methods to trigger, configure, and report such RAT-independent positioning information between target-UEs and anchor nodes has not yet been solved, especially considering different coverage scenarios including in-coverage, partial coverage, and out-of-coverage scenarios.

This disclosure presents systems, methods, and apparatuses to enable RAT-independent positioning amongst UEs and anchor nodes using the sidelink (“SL”) (PC5) interface.

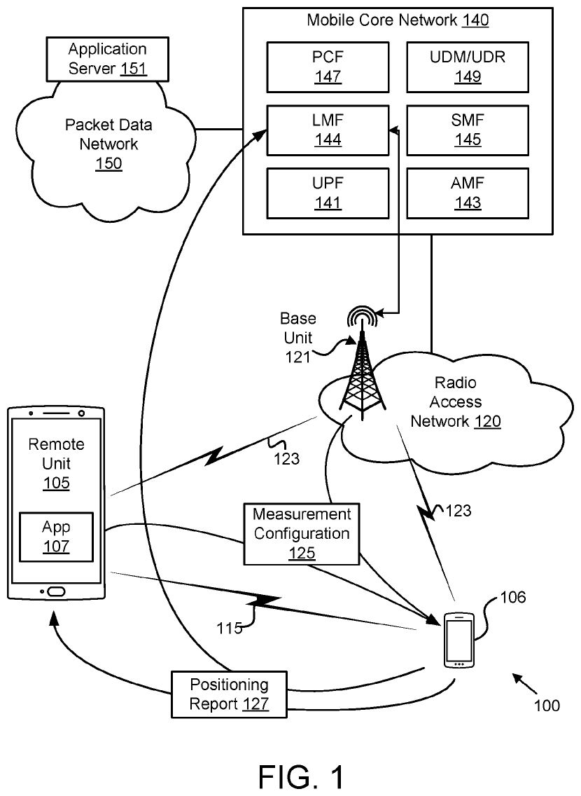

FIG. 1 depicts a wireless communication system 100 for RAT-independent positioning in sidelink, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 140. As described in greater detail below, the base unit(s) 121 may provide a cell operating using a first frequency range and/or a cell operating using a second frequency range.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

To establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, e.g., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (e.g., shared) radio spectrum.

In one embodiment, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Location Management Function (“LMF”) 144, a Unified Data Management function (“UDM”) and a User Data Repository (“UDR”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (DN), in the 5G architecture. The AMF 143 is responsible for termination of NAS signaling, NAS ciphering & integrity protection, registration management, connection management, mobility management, access authentication and authorization, security context management. The SMF 145 is responsible for session management (e.g., session establishment, modification, release), remote unit (e.g., UE) IP address allocation & management, DL data notification, and traffic steering configuration of the UPF 141 for proper traffic routing.

The LMF 144 receives positioning measurements or estimates from RAN 120 and the remote unit 105 (e.g., via the AMF 143) and computes the position of the remote unit 105. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Policy Control Function (“PCF”) (which provides policy rules to CP functions), a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“cMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for case of illustration, but their support is assumed.

In one embodiment, the remote unit 105 may be an initiator device and transmits a positioning measurement configuration 125 to a responder device 106. In some embodiments, the initiator device may be a base unit 121, e.g., agNB. In one embodiment, the initiator device receives a positioning/measurement report 127 from the responder device 106. In one embodiment, the initiator device sends the measurement configuration, and/or other configurations, and receives the positioning report 127 over a sidelink connection 115 between the initiator device and the responder device 106. As used herein, a sidelink connection 115 allows remote units 105 to communicate directly with each other (e.g., device-to-device communication) using sidelink (e.g., V2X communication) signals.

While FIG. 1 depicts components of a 5G RAN and a 5G core network, the described embodiments for RAT-independent positioning in sidelink apply to other types of communication networks and RATs, including IEEE 802.11 variants, Global System for Mobile Communications (“GSM”, e.g., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station but it is replaceable by any other radio access node, e.g., gNB, ng-CNB, cNB, Base Station (“BS”), Access Point (“AP”), etc. Further, the operations are described mainly in the context of 5G NR. However, the proposed solutions/methods are also equally applicable to other mobile communication systems supporting sidelink power control for positioning reference signal transmission.

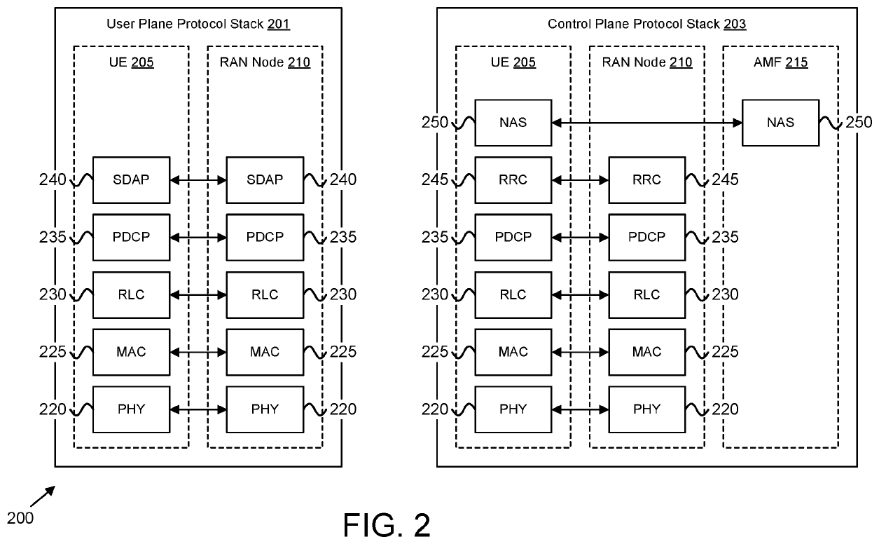

FIG. 2 depicts a NR protocol stack 200, according to embodiments of the disclosure. While FIG. 2 shows the UE 205, the RAN node 210 and an AMF 215 in a 5G core network (“5GC”), these are representative of a set of remote units 105 interacting with a base unit 121 and a mobile core network 140. As depicted, the protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) layer 240. The Control Plane protocol stack 203 includes a physical layer 220, a MAC sublayer 225, a RLC sublayer 230, and a PDCP sublayer 235. The Control Plane protocol stack 203 also includes a Radio Resource Control (“RRC”) layer 245 and a Non-Access Stratum (“NAS”) layer 250.

The AS layer (also referred to as “AS protocol stack”) for the User Plane protocol stack 201 consists of at least SDAP, PDCP, RLC and MAC sublayers, and the physical layer. The AS layer for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 245 and the NAS layer 250 for the control plane and includes, e.g., an Internet Protocol (“IP”) layer and/or PDU Layer (not depicted) for the user plane. L1 and L2 are referred to as “lower layers,” while L3 and above (e.g., transport layer, application layer) are referred to as “higher layers” or “upper layers.”

The physical layer 220 offers transport channels to the MAC sublayer 225. The physical layer 220 may perform a Clear Channel Assessment and/or Listen-Before-Talk (“CCA/LBT”) procedure using energy detection thresholds, as described herein. In certain embodiments, the physical layer 220 may send a notification of UL Listen-Before-Talk (“LBT”) failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and the 5GC 215. NAS messages are passed transparently through the RAN. The NAS layer 250 is used to manage the establishment of communication sessions and for maintaining continuous communications with the UE 205 as it moves between different cells of the RAN. In contrast, the AS layer is between the UE 205 and the RAN (e.g., RAN node 210) and carries information over the wireless portion of the network.

As background, NR positioning based on NR Uu signals and standalone access (“SA”) architecture (e.g., beam-based transmissions) is specified in Rel-16. The target use cases also included commercial and regulatory (e.g., emergency services) scenarios, as in Rel-15. The performance requirements are the following (e.g., from TR 38.855, incorporated herein by reference):

TABLE 1
Rel. 16 Positioning Performance Requirements

| Positioning Error | Indoor | Outdoor |
|---|---|---|
| Horizontal Positioning | <3 m for 80% of UEs | <10 m for 80% of UEs |
| Vertical Positioning | <3 m for 80% of UEs | <3 m for 80% of UEs |

3GPP Rel-17 positioning defines the positioning performance requirements for commercial and IIoT use cases as follows (e.g., from TR 38.857, incorporated herein by reference):

TABLE 2
Rel. 17 Positioning Performance Requirements

| Positioning Error | Commercial | IIOT |
|---|---|---|
| Horizontal Positioning | (<1 m) for 90% of UEs | (<0.2 m) for 90% of UEs; |
| Vertical Positioning | (<3 m) for 90% of UEs | (<1 m) for 90% of UEs |
| Physical layer latency | (<10 ms) | (<10 ms) |
| for position estimation | | |
| of UE | | |
| End-to-End Latency | (<100 ms) | (<100 ms, in the order |
| for position estimation | | of 10 ms is desired) |
| of UE | | |

Some UE positioning techniques supported in Rel-16 are listed in Table 3. The separate positioning techniques as indicated in Table 3 may be currently configured and performed based on the requirements of the LMF and/or UE capabilities. Note that Table 3 includes Terrestrial Beacon System (“TBS”) positioning based on PRS signals, but only observed time difference of arrival (“OTDOA”) based on LTE signals is supported. The E-CID includes Cell-ID for NR method. The TBS method refers to TBS positioning based on Metropolitan Beacon System (“MBS”) signals.

TABLE 3
Supported Rel-16 UE positioning methods

| | | UE-assisted, | NG-RAN node | Secure User Plane Location |
|---|---|---|---|---|
| Method | UE-based | LMF-based | assisted | (“SUPL”) |
| A-GNSS | Yes | Yes | No | Yes (UE-based and |
| | | | | UE-assisted) |
| OTDOA | No | Yes | No | Yes (UE-assisted) |
| E-CID | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS | Yes | Yes | No | Yes |
| | | | | (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

The transmission of PRS enable the UE to perform UE positioning-related measurements to enable the computation of a UE's location estimate and are configured per Transmission Reception Point (“TRP”), where a TRP may transmit one or more beams.

FIG. 3 depicts an overview of one embodiment of the absolute and relative positioning scenarios as defined in the architectural (stage 1) specifications using three different co-ordinate systems: Absolute Positioning, fixed coordinate systems 302: Relative Positioning, variable and moving coordinate system 304; and Relative Positioning, variable coordinate system 306.

In one embodiment, the following RAT-dependent positioning techniques may be supported by the system 100:

DL-TDoA: The downlink time difference of arrival (“DL-TDOA”) positioning method makes use of the DL RS Time Difference (“RSTD”) (and optionally DL PRS RS Received Power (“RSRP”) of DL PRS RS Received Quality (“RSRQ”)) of downlink signals received from multiple TPs, at the UE (e.g., remote unit 105). The UE measures the DL RSTD (and optionally DL PRS RSRP) of the received signals using assistance data received from the positioning server, and the resulting measurements are used along with other configuration information to locate the UE in relation to the neighboring Transmission Points (“TPs”).

DL-AoD: The DL Angle of Departure (“AoD”) positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

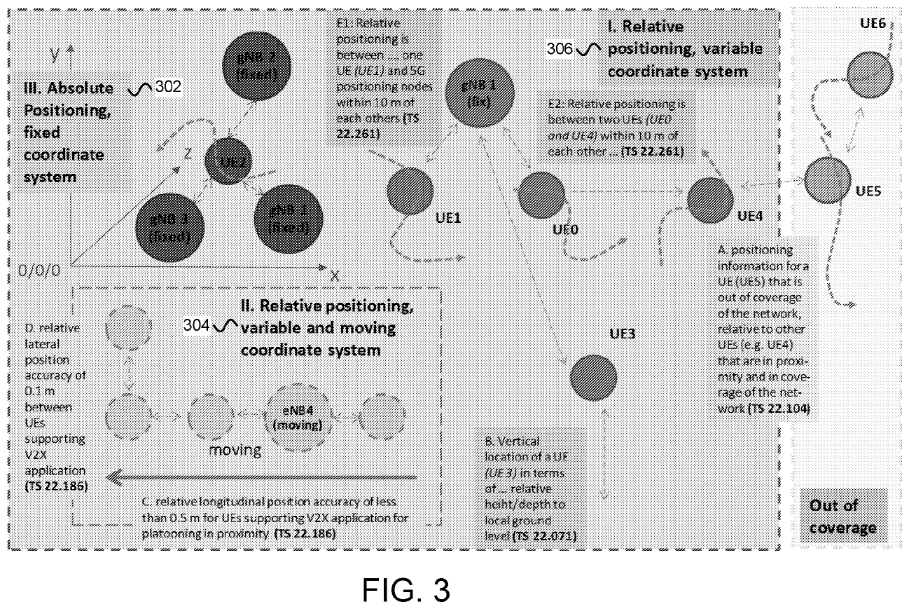

Multi-RTT: The Multiple-Round Trip Time (“Multi-RTT”) positioning method makes use of the UE Receive-Transmit (“Rx-Tx”) measurements and DL PRS RSRP of downlink signals received from multiple TRPs, measured by the UE and the gNB Rx-Tx measurements (e.g., measured by RAN node) and UL SRS-RSRP at multiple TRPs of uplink signals transmitted from UE, as shown in FIG. 4.

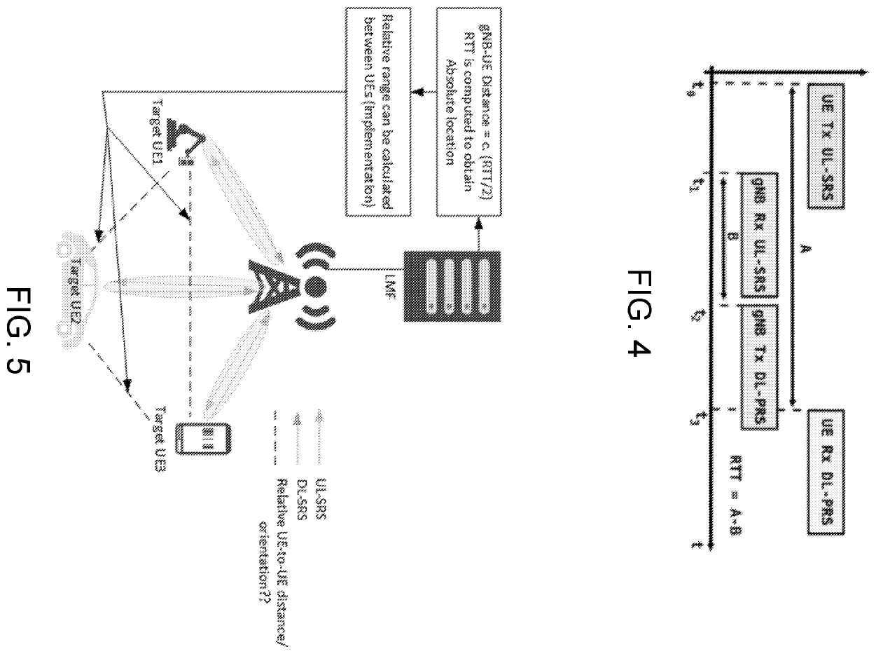

As shown in FIG. 5, the UE measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the Round Trip Time (“RTT”) at the positioning server which are used to estimate the location of the UE. In one embodiment, Multi-RTT is only supported for UE-assisted/NG-RAN assisted positioning techniques, as noted in Table 3.

E-CID/NR E-CID: Enhanced Cell ID (“CID”) positioning method, the position of a UE is estimated with the knowledge of its serving ng-eNB, gNB and cell and is based on LTE signals. The information about the serving ng-eNB, gNB and cell may be obtained by paging, registration, or other methods. NR Enhanced Cell ID (“NR E-CID”) positioning refers to techniques which use additional UE measurements and/or NR radio resource and other measurements to improve the UE location estimate using NR signals.

Although NR E-CID positioning may utilize some of the same measurements as the measurement control system in the RRC protocol, the UE generally is not expected to make additional measurements for the sole purpose of positioning: e.g., the positioning procedures do not supply a measurement configuration or measurement control message, and the UE reports the measurements that it has available rather than being required to take additional measurement actions.

UL-TDoA: The UL TDOA positioning method makes use of the UL TDOA (and optionally UL SRS-RSRP) at multiple reception points (“RPs”) of uplink signals transmitted from the UE. The RPs measure the UL TDOA (and optionally UL SRS-RSRP) of the received signals using assistance data received from the positioning server, and the resulting measurements are used along with other configuration information to estimate the location of the UE.

UL-AoA: The UL Angle of Arrival (“AoA”) positioning method makes use of the measured azimuth and the zenith angles of arrival at multiple RPs of uplink signals transmitted from the UE. The RPs measure A-AoA and Z-AoA of the received signals using assistance data received from the positioning server, and the resulting measurements are used along with other configuration information to estimate the location of the UE.

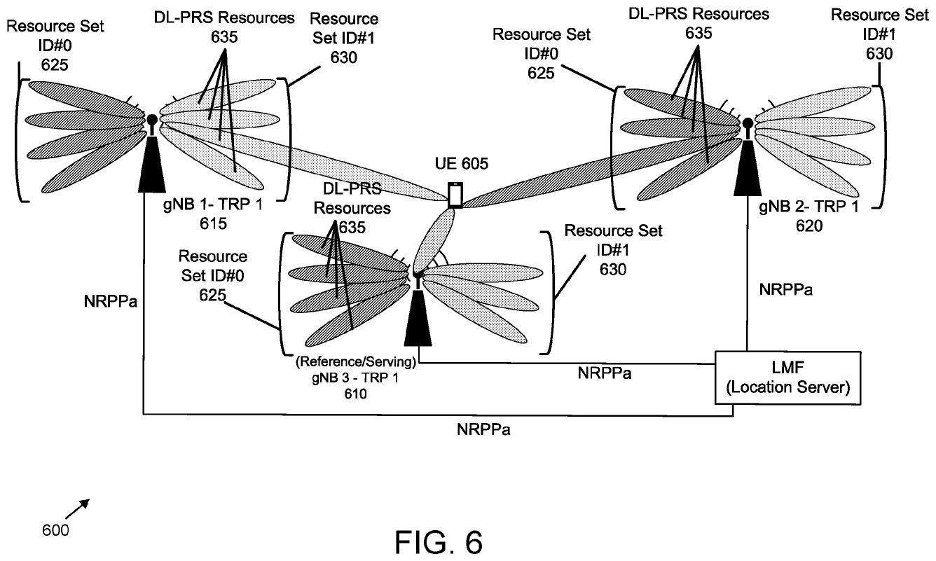

According to Rel-16, the PRS can be transmitted by different base stations (serving and neighboring) using narrow beams over FR1 and FR2 as illustrated in FIG. 6, which is relatively different when compared to LTE where the PRS was transmitted across the whole cell. The PRS can be locally associated with a PRS Resource ID and Resource Set ID for a base station (TRP). Similarly, UE positioning measurements such as Reference Signal Time Difference (RSTD) and PRS RSRP measurements are made between beams (e.g., between a different pair of DL PRS resources or DL PRS resource sets) as opposed to different cells as was the case in LTE. In addition, there are additional UL positioning methods for the network to exploit in order to compute the target UE's location. Tables 4 and 5 show the reference signal to measurements mapping required for each of the supported RAT-dependent positioning techniques at the UE and gNB, respectively. RAT-dependent positioning techniques involve the 3GPP RAT and core network entities to perform the position estimation of the UE, which are differentiated from RAT-independent positioning techniques which rely on GNSS, IMU sensor, WLAN and Bluetooth technologies for performing target device (UE) positioning.

In one embodiment, the following RAT-independent positioning techniques may be supported by the system 100:

Network-assisted GNSS methods: these methods make use of UEs that are equipped with radio receivers capable of receiving GNSS signals. In 3GPP specifications the term GNSS encompasses both global and regional/augmentation navigation satellite systems. Examples of global navigation satellite systems include GPS, Modernized GPS, Galileo, GLONASS, and BeiDou Navigation Satellite System (“BDS”). Regional navigation satellite systems include Quasi Zenith Satellite System (“QZSS”) while the many augmentation systems, are classified under the generic term of Space Based Augmentation Systems (“SBAS”) and provide regional augmentation services. In this concept, different GNSSs (e.g. GPS, Galileo, etc.) can be used separately or in combination to determine the location of a UE.

Barometric pressure sensor positioning: the barometric pressure sensor method makes use of barometric sensors to determine the vertical component of the position of the UE. The UE measures barometric pressure, optionally aided by assistance data, to calculate the vertical component of its location or to send measurements to the positioning server for position calculation. This method should be combined with other positioning methods to determine the 3D position of the UE.

WLAN positioning: the WLAN positioning method makes use of the WLAN measurements (AP identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Alternatively, the UE makes use of WLAN measurements and optionally WLAN AP assistance data provided by the positioning server, to determine its location.

Bluetooth positioning: the Bluetooth positioning method makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g. WLAN) to improve positioning accuracy of the UE.

TBS positioning: a TBS consists of a network of ground-based transmitters, broadcasting signals only for positioning purposes. The current type of TBS positioning signals are the MBS signals and PRS signals. The UE measures received TBS signals, optionally aided by assistance data, to calculate its location or to send measurements to the positioning server for position calculation.

Motion sensor positioning: the motion sensor method makes use of different sensors such as accelerometers, gyros, magnetometers, to calculate the displacement of UE. The UE estimates a relative displacement based upon a reference position and/or reference time. UE sends a report comprising the determined relative displacement which can be used to determine the absolute position. This method should be used with other positioning methods for hybrid positioning.

FIG. 6 depicts a system 600 for NR beam-based positioning. According to Rel-16, the PRS can be transmitted by different base stations (serving and neighboring) using narrow beams over Frequency Range #1 Between (“FR1”, e.g., frequencies from 410 MHz to 7125 MHz) and Frequency Range #2 (“FR2”, e.g., frequencies from 24.25 GHz to 52.6 GHz), which is relatively different when compared to LTE where the PRS was transmitted across the whole cell.

As illustrated in FIG. 6, a UE 605 may receive PRS from a first gNB (“gNB 3”) 610, which is a serving gNB, and also from a neighboring second gNB (“gNB 1”) 615, and a neighboring third gNB (“gNB 2”) 620. Here, the PRS can be locally associated with a set of PRS Resources grouped under a Resource Set ID for a base station (e.g., TRP). In the depicted embodiments, each gNB 610, 615, 620 is configured with a first Resource Set ID 625 and a second Resource Set ID 630. As depicted, the UE 605 receives PRS on transmission beams; here, receiving PRS from the gNB 3 610 on a set of PRS Resources 635 from the second Resource Set ID 630, receiving PRS from the gNB 1 615 on a set of PRS Resources 635 from the second Resource Set ID 630, and receiving PRS from the gNB 2 620 on a set of PRS Resources 635 from the first Resource Set ID 625.

Similarly, UE positioning measurements such as Reference Signal Time Difference (“RSTD”) and PRS RSRP measurements are made between beams as opposed to different cells as was the case in LTE. In addition, there are additional UL positioning methods for the network to exploit to compute the target UE's location. Table 4 lists the RS-to-measurements mapping required for each of the supported RAT-dependent positioning techniques at the UE, and Table 5 lists the RS-to-measurements mapping required for each of the supported RAT-dependent positioning techniques at the gNB.

TABLE 4
UE Measurements to enable RAT-dependent positioning techniques

| | | To facilitate support |
|---|---|---|
| | | of the following |
| DL/UL Reference Signals | UE Measurements | positioning techniques |
| Rel-16 DL PRS | DL RSTD | DL-TDOA |
| Rel-16 DL PRS | DL PRS RSRP | DL-TDOA, DL-AoD, |
| | | Multi-RTT |
| Rel-16 DL PRS/Rel-16 | UE Rx − Tx time | Multi-RTT |
| SRS for positioning | difference | |
| Rel. 15 SSB/CSI-RS | SS-RSRP(RSRP for RRM), | E-CID |
| for RRM | SS-RSRQ(for RRM), | |
| | CSI-RSRP (for RRM), | |
| | CSI-RSRQ (for RRM), | |
| | SS-RSRPB (for RRM) | |

TABLE 5
gNB Measurements to enable RAT-
dependent positioning techniques

| | | To facilitate support |
|---|---|---|
| | | of the following |
| DL/UL Reference Signals | gNB Measurements | positioning techniques |
| Rel-16 SRS for positioning | UL RTOA | UL-TDOA |
| Rel-16 SRS for positioning | UL SRS-RSRP | UL-TDOA, UL-AoA, |
| | | Multi-RTT |
| Rel-16 SRS for positioning, | gNB Rx − Tx time | Multi-RTT |
| Rel-16 DL PRS | difference | |
| Rel-16 SRS for positioning, | A-AoA and Z-AoA | UL-AoA, Multi-RTT |

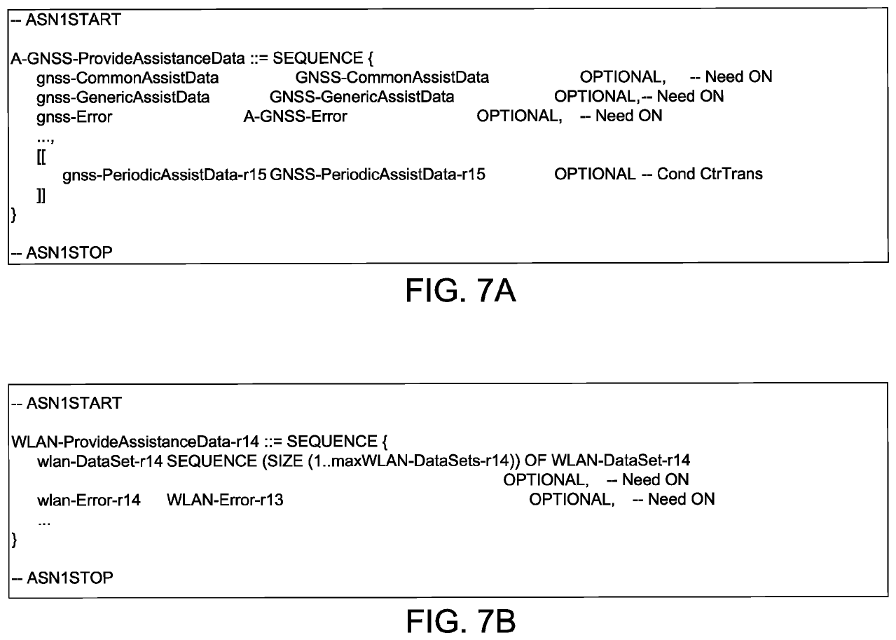

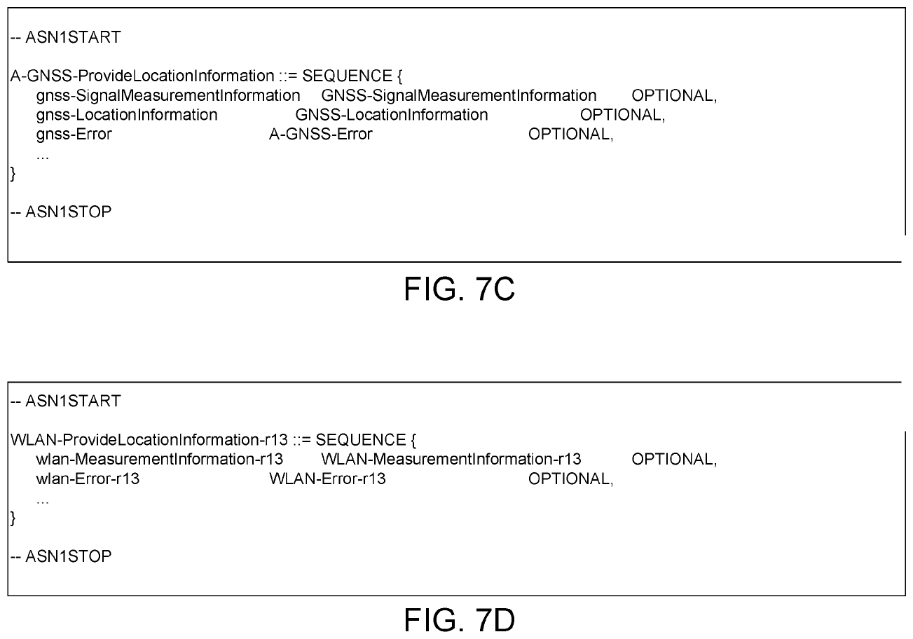

For a conceptual overview of the current implementation in Rel-16, the RAT-independent configurations including A-GNSS (see FIG. 7A) and WLAN (see FIG. 7BError! Reference source not found.) and associated A-GNSS and WLAN measurement reporting information (see FIG. 7C and FIG. 7D). The IE A-GNSS-ProvideLocationInformation is used by the target device to provide location measurements (e.g., pseudo ranges, location estimate, velocity) to the location server, together with time information. It may also be used to provide GNSS positioning specific error reason.

The IE A-GNSS-Provide Assistance Data is used by the location server to provide assistance data to enable UE-assisted and UE-based A-GNSS. It may also be used to provide GNSS positioning specific error reasons.

The IE WLAN-ProvideAssistance Data is used by the location server to provide assistance data to enable UE-based and UE-assisted WLAN positioning. It may also be used to provide WLAN positioning specific error reason.

The IE A-GNSS-ProvideLocationInformation is used by the target device to provide location measurements (e.g., pseudo-ranges, location estimate, velocity) to the location server, together with time information. It may also be used to provide GNSS positioning specific error reason.

The IE WLAN-ProvideLocationInformation is used by the target device to provide measurements for one or more WLANs to the location server. It may also be used to provide WLAN positioning specific error reason.

Regarding RAT-dependent positioning measurements, the different DL measurements including DL PRS-RSRP, DL RSTD and UE Rx-Tx Time Difference required for the supported RAT-dependent positioning techniques are shown in Table 6. The following measurement configurations are specified, e.g., in TS 38.215 (incorporated herein by reference):

4 Pair of DL RSTD measurements can be performed per pair of cells. Each measurement is performed between a different pair of DL PRS Resources/Resource Sets with a single reference timing.

8 DL PRS RSRP measurements can be performed on different DL PRS resources from the same cell.

TABLE 6
DL Measurements required for DL-based positioning methods
DL PRS reference signal received power (DL PRS-RSRP)

| | |
|---|---|
| Definition | DL PRS reference signal received power (DL PRS-RSRP), is defined as the |
| | linear average over the power contributions (in [W]) of the resource elements |
| | that carry DL PRS reference signals configured for RSRP measurements within |
| | the considered measurement frequency bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements corresponding |
| | to a given receiver branch. For frequency range 1 and 2, if receiver diversity is |
| | in use by the UE, the reported DL PRS-RSRP value shall not be lower than the |
| | corresponding DL PRS-RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe received |
| | from positioning node j. |
| | Multiple DL PRS resources can be used to determine the start of one subframe |
| | from a positioning node. |
| | For frequency range 1, the reference point for the DL RSTD shall be the |
| | antenna connector of the UE. For frequency range 2, the reference point for the |
| | DL RSTD shall be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for T_{UE-RX} measurement shall be the |
| | Rx antenna connector of the UE and the reference point for T_{UE-TX} measurement |
| | shall be the Tx antenna connector of the UE. For frequency range 2, the |
| | reference point for T_{UE-RX} measurement shall be the Rx antenna of the UE and |
| | the reference point for T_{UE-TX} measurement shall be the Tx antenna of the UE. |
| Applicable for | RRC_CONNECTED intra-frequency |
| | RRC_CONNECTED inter-frequency |

In one embodiment, integrity and reliability of the positioning estimate is defined by the following parameters:
Alert limit (“AL”): The maximum allowable positioning error such that the positioning system is available for the intended application. If the positioning error is beyond the AL, operations are hazardous and the positioning system should be declared unavailable for the intended application to prevent loss of integrity.
   NOTE: When the AL bounds the positioning error in the horizontal plane or on the vertical axis then it is called Horizontal Alert Limit (“HAL”) or Vertical Alert Limit (“VAL”) respectively.
Time to alert (“TTA”): The probability that the positioning error exceeds the ALwithout warning the user within the required TTA.
   NOTE: The TIR is usually defined as a probability rate per some time unit (e.g. per hour, per second or per independent sample).
Target Integrity Risk (“TIR”): The maximum allowable elapsed time from when the positioning error exceeds the AL until the function providing position integrity annunciates a corresponding alert.

The present disclosure details solutions for supporting RAT-independent positioning using SL (e.g., PC5 interface) for improving absolute and relative positioning/ranging. An overview of the solutions is presented as follows:
A method to configure a wireless device with RAT-independent positioning assistance data using sidelink (PC5 interface) to support hybrid SL RAT-dependent and RAT-independent positioning.
   The RAT-independent configuration may comprise of non-3GPP positioning techniques comprising A-GNSS, WLAN, and Bluetooth.
A method to configure the wireless device to receive a reporting configuration and report configured RAT-independent positioning methods associated with qualitative metrics using sidelink (PC5 interface).
A method to enable a wireless device to transmit error indications associated with both RAT-dependent and RAT-independent positioning methods using sidelink (PC5 interface).
A method to support RAT-independent capability information exchange between two wireless devices performing SL RAT-independent positioning.

As used herein, the term “controller” may refer to a device that controls the ranging session and defines the ranging parameters by sending the ranging control information, the term “controlee” may refer to a device that utilizes the ranging parameters received from the controller by decoding the ranging control message, the term “initiator device” may refer to a device that initiates a SL positioning/ranging session, and the term “responder device” may refer to a device that responds to a SL positioning/ranging session from an initiator device. Further, as used herein, a target-UE may be referred to as a UE of interest whose position (absolute or relative) is to be obtained by the network or by the UE itself.

It is noted that the embodiments below may be implemented in combination with each other to support NR RAT-independent positioning over the SL (PC5) interface. For the purposes of this disclosure, a positioning-related reference signal may be referred to as a reference signal used for positioning procedures/purposes in order to estimate a target-UE's location, e.g., PRS, or based on existing reference signals such as CSI-RS or SRS: a target-UE may be referred to as the device/entity to be localized/positioned. In various embodiments, the term ‘PRS’ may refer to any signal such as a reference signal, which may or may not be used primarily for positioning.

According to a first embodiment, a SL capable device or network entity may configure another UE or group of UEs with RAT-independent positioning methods for the purposes of performing positioning, especially in out-of-coverage scenarios in addition to leveraging hybrid positioning solutions in combination with SL RAT-dependent positioning techniques.

In one embodiment, A-GNSS as a RAT-independent positioning technique is enabled over SL (PC5 interface) via a configuration and corresponding report detailed below. Network-assisted GNSS support over SL can enable rapid acquisition of absolute positioning estimates in addition to relative location estimation (using absolute location estimates). This may include support from global, regional and augmentation satellite systems. A-GNSS configuration can support the following scenarios:
Scenario 1: UE-based UE-configured A-GNSS positioning-A UE supporting SL performs GNSS measurements and calculates its own location, based on in part additional information/measurements received from other sources, e.g., reference station measurements, reference UE/reference TRP measurements, and configuration signaling assistance data from other UEs or anchor UEs.
Scenario 2: UE-based network configured A-GNSS positioning-A UE supporting SL performs GNSS measurements and calculates its own location, based on in part additional information/measurements received from other sources, e.g., reference station measurements, reference UE/reference TRP/reference roadside units measurements, and configuration signaling assistance data from network entities including base station (e.g. gNBs), roadside units, location server, or the like.
Scenario 3: UE-assisted UE-configured A-GNSS positioning-A network entity such as base station (e.g. gNBs), roadside units, location server, or the like receives a GNSS measurements and calculates the location of the desired target-UE or group of target-UEs, based on in part additional information/measurements received from other sources, e.g., reference station measurements, reference UE/reference TRP measurements, and configuration signaling assistance data from other UEs or anchor UEs.
Scenario 4: UE-assisted network configured A-GNSS positioning-A network entity such as base station (e.g. gNBs), roadside units, location server, or the like receives a GNSS measurements and calculates the location of the desired target-UE or group of target-UEs based on in part additional information/measurements received from other sources, e.g., reference station measurements, reference UE/reference TRP/reference roadside units measurements, and configuration signaling assistance data from network entities including base station (e.g. gNBs), roadside units, location server, or the like.

Depending on the requirements of the location request, triggers or events for initiating A-GNSS positioning over SL may include:
Absolute/relative horizontal/vertical positioning/height accuracy and velocity requirements
Exceeding a configured horizontal/vertical positioning threshold
   Can be based on a function of a provided time interval and hysteresis value (to prevent false triggers)
Delta change compared to previous absolute/relative horizontal/vertical positioning/height and/or velocity estimate
Positioning Latency (time to first fix)
Coverage scenarios including in-coverage, partial coverage, and out-of-coverage

In another implementation, the location request may necessitate the use of hybrid positioning based on both RAT-dependent and RAT-independent positioning methods including A-GNSS.

The following exemplary assistance data (A-GNSS configuration) elements may be signaled via PC5 interface to other entities as described above:

TABLE 7
SL A-GNSS Configuration/Assistance Data

| | SL A-GNSS | |
|---|---|---|
| | Configuration/ | |
| No. | Assistance Data | Description |
| 1 | Reference | Reference Time assistance provides the GNSS receiver |
| | Time | embedded in a SL capable device with coarse or fine GNSS |
| | | time information. The specific GNSS system times (e.g., GPS, |
| | | Galileo, GLONASS, BDS system time) shall be indicated with |
| | | a GNSS ID. |
| | | In case of coarse time assistance only, the Reference Time |
| | | provides an estimate of the current GNSS system time (where |
| | | the specific GNSS is indicated by a GNSS ID). The SL |
| | | capable wireless device should achieve an accuracy of ±3 |
| | | seconds for this time including allowing for the transmission |
| | | delay between one SL node and the target-UE. |
| | | In case of fine time assistance, the Reference Time provides |
| | | the relation between GNSS system time (where the specific |
| | | GNSS is indicated by a GNSS ID) and SL air-interface timing. |
| 2 | Reference | Reference Location assistance provides the GNSS receiver |
| | Location | embedded in a SL capable device with an a priori estimate of |
| | | its location (e.g., obtained via other positioning methods |
| | | including Cell-ID, Zone ID, OTDOA positioning, SL RAT- |
| | | dependent positioning methods, etc.) together with its |
| | | uncertainty. |
| | | The geodetic reference frame shall be WGS-84, as specified in |
| | | TS 23.032. |
| 3 | Ionospheric | Ionospheric Model assistance provides the GNSS receiver |
| | Models | embedded in a SL capable device with parameters to model |
| | | the propagation delay of the GNSS signals through the |
| | | ionosphere. Ionospheric Model parameters as specified by |
| | | GPS, Galileo, QZSS, and BDS may be provided. |
| 4 | Earth | Earth Orientation Parameters (EOP) assistance provides the |
| | Orientation | GNSS receiver embedded in a SL capable device with |
| | Parameters | parameters needed to construct the ECEF-to-ECI coordinate |
| | | transformation as specified by GPS. |
| 5 | GNSS-GNSS | GNSS-GNSS Time Offsets assistance provides the GNSS |
| | Time | receiver embedded in a SL capable device with parameters to |
| | Offsets | correlate GNSS time (where the specific GNSS is indicated by |
| | | a GNSS-1 ID) of one GNSS with other GNSS time (where the |
| | | specific GNSS is indicated by a GNSS-2 ID). GNSS-GNSS |
| | | Time Offsets parameters as specified by GPS, Galileo, |
| | | GLONASS, QZSS, and BDS may be provided. |
| 6 | Differential | Differential GNSS Corrections assistance provides the GNSS |
| | GNSS | receiver embedded in a SL capable device with pseudo-range |
| | Corrections | and pseudo-range-rate corrections to reduce biases in GNSS |
| | | receiver measurements as specified in [RTCM 10402.3, |
| | | RTCM Recommended Standards for Differential GNSS |
| | | Service]. The specific GNSS for which the corrections are |
| | | valid is indicated by a GNSS-ID |
| 7 | Ephemeris | Ephemeris and Clock Models assistance provides the GNSS |
| | and Clock | receiver embedded in a SL capable device with parameters to |
| | Models | calculate the GNSS satellite position and clock offsets. The |
| | | various GNSSs use different model parameters and formats, |
| | | and all parameter formats as defined by the individual GNSSs |
| | | are supported by the signaling. |
| 8 | Real-Time | Real-Time Integrity assistance provides the GNSS receiver |
| | Integrity | embedded in a SL capable device with information about the |
| | | health status of a GNSS constellation (where the specific |
| | | GNSS is indicated by a GNSS ID) |
| 9 | Data Bit | Data Bit Assistance provides the GNSS receiver embedded in |
| | Assistance | a SL capable device with information about data bits or |
| | | symbols transmitted by a GNSS satellite at a certain time |
| | | (where the specific GNSS is indicated by a GNSS ID). This |
| | | information may be used by the UE for sensitivity assistance |
| | | (data wipe-off) and time recovery |
| 10 | Acquisition | Acquisition Assistance provides the GNSS receiver embedded |
| | Assistance | in a SL capable device with information about visible/in- |
| | | coverage satellites, reference time, expected code-phase, |
| | | expected Doppler, search windows (i.e., code and Doppler |
| | | uncertainty) and other information of the GNSS signals (where |
| | | the specific GNSS is indicated by a GNSS ID) to enable a fast |
| | | acquisition of the GNSS signals. |
| 11 | Almanac | Almanac assistance provides the GNSS receiver embedded in |
| | | a SL capable device with parameters to calculate the coarse |
| | | (long-term) GNSS satellite position and clock offsets. The |
| | | various GNSSs use different model parameters and formats, |
| | | and all parameter formats as defined by the individual GNSSs |
| | | are supported by the signaling. |
| 12 | UTC | UTC Models assistance provides the GNSS receiver |
| | Models | embedded in a SL capable device with parameters needed to |
| | | relate GNSS system time (where the specific GNSS is |
| | | indicated by a GNSS ID) to Universal Coordinated Time. The |
| | | various GNSSs use different model parameters and formats, |
| | | and all parameter formats as defined by the individual GNSSs |
| | | are supported by the signaling |
| 13 | RTK Reference | RTK Reference Station Information provides the GNSS |
| | Station | receiver with the Earth-Centered, Earth-Fixed (ECEF) |
| | Information | coordinates of the Reference Station's installed antenna's ARP, |
| | | and the height of the ARP above the survey monument. |
| | | Additionally, this assistance data provides information about |
| | | the antenna type installed at the reference site. |
| | | NOTE: With the MAC N-RTK technique this assistance data is |
| | | used to provide information regarding the Master Reference |
| | | Station (see clause 8.1.2.1a) |
| 14 | RTK Auxiliary | RTK Auxiliary Station Data provides the GNSS receiver with |
| | Station Data | the location for all Auxiliary Reference Stations (see clause |
| | | 8.1.2.1a) within the assistance data. These values are |
| | | expressed as relative geodetic coordinates (latitude, longitude, |
| | | and height) with respect to a Master Reference Station (see |
| | | clause 8.1.2.1a) and based on the GRS80 ellipsoid. This type |
| | | of assistance data is relevant only with the MAC N-RTK |
| | | technique |
| 15 | RTK Observations | RTK Observations provides the GNSS receiver with all |
| | | primary observables (pseudo-range, phase-range, phase-range |
| | | rate (Doppler), and carrier-to-noise ratio) generated at the |
| | | Reference Station for each GNSS signal. |
| | | The pseudo-range is the distance between the satellite and |
| | | GNSS receiver antennas, expressed in meters, equivalent to |
| | | the difference of the time of reception (expressed in the time |
| | | frame of the GNSS receiver) and the time of transmission |
| | | (expressed in the time frame of the satellite) of a distinct |
| | | satellite signal. |
| | | The phase-range measurement is a measurement of the range |
| | | between a satellite and receiver expressed in units of cycles of |
| | | the carrier frequency. This measurement is more precise than |
| | | the pseudo-range (of the order of millimeters), but it is |
| | | ambiguous by an unknown integer number of wavelengths. |
| | | The phase-range rate is the rate at which the phase-range |
| | | between a satellite and a GNSS receiver changes over a |
| | | particular period of time. |
| | | The carrier-to-noise ratio is the ratio of the received modulated |
| | | carrier signal power to the noise power after the GNSS |
| | | receiver filters. |
| 16 | RTK Common | RTK Common Observation Information provides the GNSS |
| | Observation | receiver with common information applicable to any GNSS, |
| | Information | e.g., clock steering indicator. |
| 17 | GLONASS | RTK Bias Information provides the GNSS receiver with |
| | RTK Bias | information which is intended to compensate for the first-order |
| | Information | inter-frequency phase-range biases introduced by the reference |
| | | receiver code-phase biases. This information is applicable only |
| | | for GLONASS FDMA signals. In the case that the MAC |
| | | Network RTK method is used, GLONASS RTK Bias |
| | | Information defines the code-phase biases related to the |
| | | Master Reference Station. |
| 18 | RTK MAC | RTK MAC Correction Differences provides the GNSS |
| | Correction | receiver with information about ionospheric (dispersive) and |
| | Differences | geometric (non-dispersive) corrections generated between a |
| | | Master Reference Station and its Auxiliary Reference Stations |
| 19 | RTK Residuals | RTK Residuals provides the GNSS receiver with network |
| | | error models generated for the interpolated corrections |
| | | disseminated in Network RTK techniques. With sufficient |
| | | redundancy in the RTK network, the location server process |
| | | can provide an estimate for residual interpolation errors. Such |
| | | quality estimates may be used by the target UE to optimize the |
| | | performance of RTK solutions. |
| 20 | RTK FKP | RTK FKP Gradients provides the GNSS receiver with |
| | Gradients | horizontal gradients for the geometric (troposphere and |
| | | satellite orbits) and ionospheric signal components in the |
| | | observation space. |
| 21 | SSR Orbit | SSR Orbit Corrections provides the GNSS receiver with |
| | Corrections | parameters for orbit corrections in radial, along-track and |
| | | cross-track components. These orbit corrections are used to |
| | | compute a satellite position correction, to be combined with |
| | | satellite position calculated from broadcast ephemeris. |
| 22 | SSR Clock | SSR Clock Corrections provides the GNSS receiver with |
| | Corrections | parameters to compute the GNSS satellite clock correction |
| | | applied to the broadcast satellite clock. A polynomial of order |
| | | 2 describes the clock differences for a certain time period: |
| | | clock offset, drift, and drift rate. |
| 23 | SSR Code | SSR Code Bias provides the GNSS receiver with the Code |
| | Bias | Biases that must be added to the pseudo range measurements |
| | | of the corresponding code signal to get corrected pseudo |
| | | ranges. SSR Code Bias contains absolute values, but also |
| | | enables the alternative use of Differential Code Biases by |
| | | setting one of the biases to zero. A UE can consistently use |
| | | signals for which a code bias is transmitted. |
| 24 | SSR Phase | SSR Phase Bias provides the GNSS receiver with the GNSS |
| | Bias | signal phase bias that are added to the carrier phase |
| | | measurements of the corresponding signal to get corrected |
| | | phase ranges. An indicator used to count events when phase |
| | | bias is discontinuous is provided. An optional indicator is also |
| | | provided to indicate whether fixed, widelane fixed or float |
| | | PPP-RTK positioning modes are supported on a per signal |
| | | basis. |
| 25 | SSR STEC | SSR STEC Corrections provides the GNSS receiver with the |
| | Corrections | parameters to compute the ionosphere slant delay correction |
| | | based on a variable order polynomial on a per satellite basis |
| | | and applied to the code and phase measurements. |
| 26 | SSR Gridded | SSR Gridded Corrections provides the GNSS receiver with |
| | Correction | final ionosphere slant delay (STEC) residuals and Troposphere |
| | | delays at a series of correction points and expressed as |
| | | hydrostatic and wet vertical delays. |
| 27 | SSR URA | SSR URA provides the receiver with information about the |
| | | estimated accuracy of the corrections for each satellite. |
| 28 | SSR Correction | The SSR Correction Points provides a list of correction point |
| | Points | coordinates or an array of correction points (“grid”) for which |
| | | the SSR Gridded Corrections are valid. |

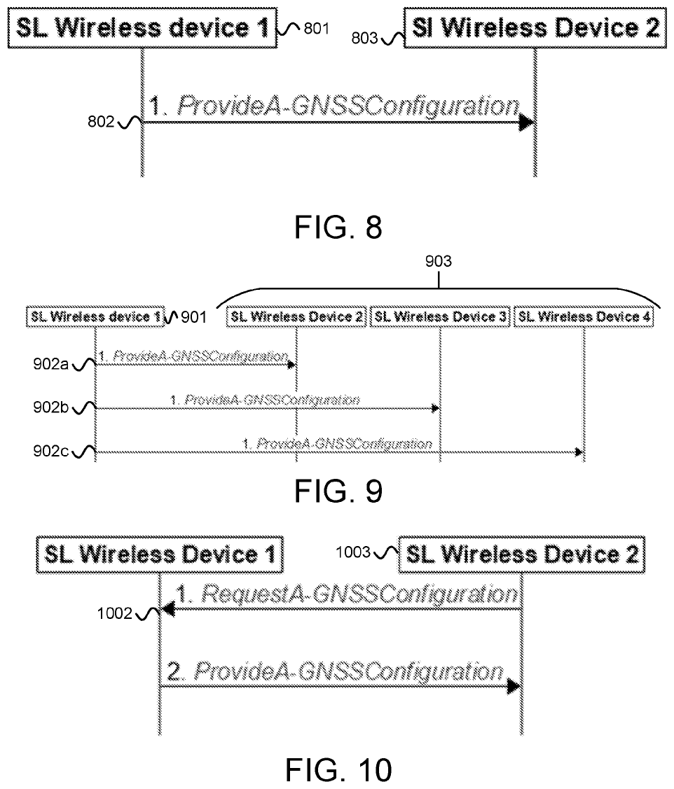

As shown in FIG. 8, subject to UE capability, such A-GNSS configuration information/assistance data may be signaled (see messaging 802) in a dedicated/unicast/groupcast/broadcast manner using PC5 RRC/MAC CE/PC5-S or possibly implemented using discovery signaling or prose/V2X application layer signaling between two capable SL devices 801, 803.

As shown in FIG. 9, in groupcast scenarios, a UE 901 may groupcast (see messaging 902a-c) the A-GNSS configuration/assistance data to multiple target-UEs 903 to efficiently share this information in a single SL positioning session.

In another implementation, the A-GNSS configuration may be broadcasted by SL capable devices, or network entities such as base stations (e.g., gNBs), roadside units, location servers, or the like or combination thereof.

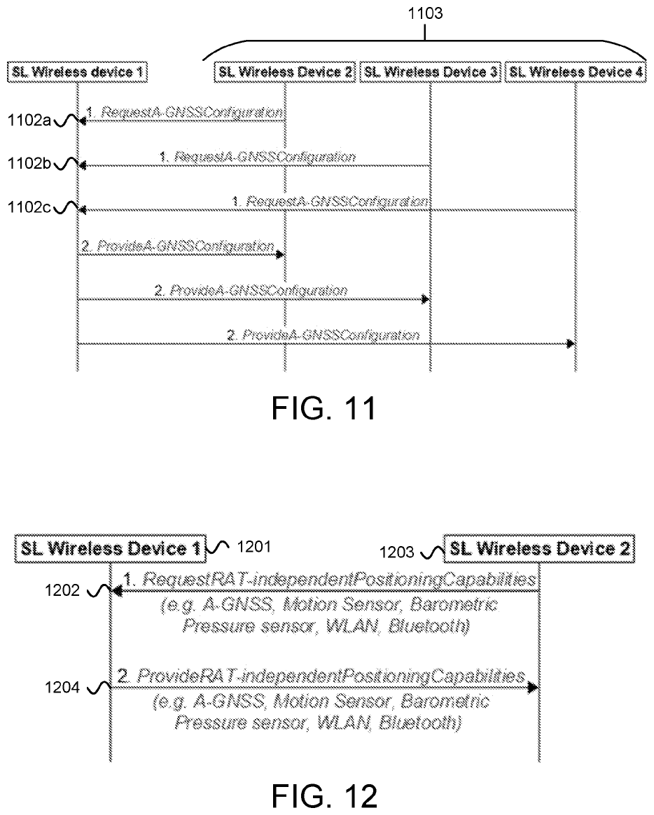

Furthermore, the A-GNSS assistance data/configuration information may be received in either a:
Unsolicited manner (Shown in FIGS. 8 and 9)
Solicited manner (e.g., in response to a request 1002, 1102a-c from a target-UE 1003, 1103, as shown in FIGS. 10 and 11)

In another implementation, one of the member UEs in a group may request a SL A-GNSS configuration on behalf of other group members and thereafter all members in the group may receive the A-GNSS configuration.

In yet another realization of the embodiment, the SL assistance data/configuration information elements can be further grouped to functionally serve the following real-time kinematic (“RTK”) service levels:
Single base RTK service (uses carrier-based ranging measurements i.e., phase-range/pseudo range error correction to improve the positioning accuracy in a differential approach. The basic concept is to reduce and remove errors common to a Reference Station, with known position, and UE pair).
Non-Physical Reference Station Network RTK service (target UE receives synthetic observations from a virtual Reference Station)
MAC Network RTK service (with a group of reference stations and a single Master station)
FKP Network RTK service (horizontal gradients of distance-dependent errors like ionosphere, troposphere and orbits are derived from a network of GNSS Reference Stations and transmitted to a target device together with raw or correction data of a corresponding Reference Station (physical or virtual)).

In another embodiment, barometric pressure sensing as a RAT-independent positioning technique is enabled over SL (PC5 interface) to allow a SL capable device to share measured atmospheric pressure and reference atmospheric pressure information to the other SL capable device in in-coverage, partial coverage and out-of-coverage scenarios. SL Devices embedded with pressure sensors can enable accurate determination of the vertical position, which can aid in 3D location estimation.

Barometric pressure sensing configuration can support the following scenarios:
Scenario 1: UE-based UE-configured barometric pressure sensing positioning-A UE supporting SL performs barometric pressure measurements and calculates its own vertical location/height. The position/location information may be based on in part additional information/measurements received from other sources as mentioned in Embodiment 1-1. The UE may receive barometric pressure configuration information from another UE(s) based on SL assistance information/positioning assistance information.
Scenario 2: UE-based network configured barometric pressure sensing positioning—A UE supporting SL performs barometric pressure measurements and calculates its own location/height. The position/location information may be based on in part additional information/measurements received from other sources as mentioned in Embodiment 1-1. The UE may receive barometric pressure configuration information from network entities including base stations (e.g., gNBs), roadside units, location server, or the like.
Scenario 3: UE-assisted UE-configured barometric pressure sensing positioning-A network entity such as base station (e.g. gNBs), roadside units, location server, or the like receives UE barometric pressure measurements and calculates the location/height of the desired target-UE or group of target-UEs The position/location information may be based on in part additional information/measurements received from other sources as mentioned in Embodiment 1-1. The UE may receive barometric pressure configuration information from another UE(s) based on SL assistance information/positioning assistance information.
Scenario 4: UE-assisted network configured barometric pressure sensing positioning-A network entity such as base station (e.g. gNBs), roadside units, location server, or the like receives UE barometric pressure measurements and calculates the location/height of the desired target-UE or group of target-UEs The position/location information may be based on: additional information/measurements received from other sources as mentioned in Embodiment 1-1. The UE may receive barometric pressure configuration information from network entities including base stations (e.g., gNBs), roadside units, location server, or the like.

Depending on the requirements of the location request triggers or events for initiating barometric pressure sensor positioning may include:
Absolute/relative horizontal/vertical positioning/height accuracy and velocity requirements
Exceeding a configured horizontal/vertical positioning threshold
   Can be based on a function of a provided time interval and hysteresis value (to prevent false triggers)
Delta change compared to previous absolute/relative horizontal/vertical positioning/height and/or velocity estimate
Positioning Latency (time to first fix)
Coverage scenarios including in-coverage, partial coverage and out-of-coverage

The following assistance data (barometric pressure sensor configuration) elements may be signaled via PC5 interface to other entities as described above:

TABLE 7
Barometric Pressure Sensor Configuration/Assistance Data

| | SL A-GNSS | |
|---|---|---|
| | Configuration/ | |
| No. | Assistance Data | Description |
| 1 | Reference | This field specifies the atmospheric pressure (Pa) nominal at |
| | pressure | sea level, EGM96 to the target. |
| | | The scale factor is 1 Pa. The value is added to the nominal |
| | | pressure of 101325 Pa. |
| 2 | Reference | This field specifies the reference position at which the pressure |
| | Position | measurement is made, as an ellipsoid point with altitude and |
| | | uncertainty ellipsoid. |
| 3 | Reference | Local temperature measurement at the reference where the |
| | Temperature | pressure measurement is made. |
| | | The scale factor 1K. The value is added to 273K. |
| 4 | Validity | Describes the validity time of the pressure measurement, |
| | duration | which can be either in the scale of milliseconds, minutes, |
| | | hours, or days. May also include a start time based on UTC |
| | | time/A-GNSS/GNSS time, network time, alternative start time |
| | | and/or total duration. |
| 5 | Pressure | Describes the rate of change of pressure. When this field is |
| | Rate | included, the reference pressure applies only at the start of the |
| | | pressure validity period. The scale factor is 10 Pa/hour. |
| 6 | Pressure | Describes the spatial geographic area in which the pressure |
| | Validity | measurements are to be valid. This area can be defined based |
| | Area | on latitude/longitudinal boundary coordinates, |
| | | rectangular/circular/ellipsoidal validity areas including |
| | | applicable width, heights, radii, SL zone information. |
| 7 | Northward | Describes the northward gradient of the reference pressure |
| | Pressure | calculated from the center of the pressure validity area. |
| | gradient | |
| 8 | Eastward | Describes the eastward gradient of the reference pressure |
| | Pressure | calculated from the center of the pressure validity area. |
| | gradient | |
| 9 | Westward | Describes the westward gradient of the reference pressure |
| | Pressure | calculated from the center of the pressure validity area. |
| | gradient | |
| 10 | Southward | Describes the southward gradient of the reference pressure |
| | Pressure | calculated from the center of the pressure validity area. |
| | gradient | |

Similar to FIGS. 9 and 10, the barometric pressure sensor configuration information may be provided in a solicited or unsolicited manner in both unicast and groupcast transmission scenarios. In another implementation, the barometric pressure configuration may be broadcasted by SL capable devices, or network entities such as base stations (e.g., gNBs), roadside units, location server, or the like or combination thereof.

In another embodiment, an SL capable device may report the RAT-independent measurement information to another UE or group of UEs using SL (PC5 interface) for the purposes of performing absolute or relative positioning. The RAT-independent information may comprise A-GNSS, motion sensor including barometric pressure sensor metrics, Bluetooth, and WLAN information.

In one embodiment, A-GNSS measurement information can be reported over SL (PC5 interface) to other UEs/SL capable devices. This can be applicable to Scenarios 1-4 as described above with reference to the first embodiment.

Table 8 shows the different A-GNSS measurement and location information elements that may be reported by SL capable devices, which are required to be reported:

TABLE 8
SL A-GNSS measurement location information report
SL A-GNSS Measurement Report

Latitude/Longitude/Altitude, together with uncertainty shape
Velocity, together with uncertainty shape
Reference Time, possibly together with GNSS to NG-RAN time association and uncertainty.
This may also include UE to UE time association, System Frame Number (SFN) time
Indication of used positioning methods in the fix
Code phase measurements, also called pseudorange
Doppler measurements
Carrier phase measurements, also called Accumulated Delta Range (ADR)
Carrier-to-noise ratio of the received signal
Measurement quality parameters for each measurement
Additional, non-GNSS related measurement information
Indication on whether the measurements were made in in-coverage, out-of-coverage or partial
coverage of a network or GNSS area

In another embodiment, motion sensor measurement information can be reported over SL (PC5 interface) to other UEs/SL capable devices. This can be applicable to Scenarios 1-4 as described above with reference to the first embodiment. The motion sensor may be embedded within a SL capable device and may include accelerometers, gyroscopes, magnetometers or the like.

Table 9 shows the different motion sensor measurement and location information elements that may be reported by SL capable devices, which are required to be reported:

TABLE 9
SL motion sensor measurement location information report
SL Motion Sensor Measurement Report

Displacement Timestamp comprising either GNSS, UTC, SFN times
Delta time duration between T_{N} and T_{N-1}
Bearing information
Orientation information including with respect to a reference orientation,
additional absolute and relative orientations
Displacement Information including horizontal and vertical distances
Measurement quality of the displacement, bearing and orientation information including
confidence intervals, uncertainty values, configured quality association metrics
e.g., good, average bad
Reference Position
Reference Time

In another embodiment, Bluetooth measurement information can be reported over SL (PC5 interface) to other UEs/SL capable devices. This can be applicable to Scenarios 1-4 as described above with reference to the first embodiment. The Bluetooth chipset may also be embedded within a SL capable device.

Table 10 shows the different Bluetooth measurement and location information elements that may be reported by SL capable devices, which are required to be reported:

TABLE 10
SL Bluetooth measurement location information report
SL Bluetooth Measurement Report

Measurement Reference Timestamp of the Bluetooth measurement whichmay include GNSS,
UTC, SFN times as a configured reference time format
Bluetooth ID including public address of beacon, pre-defined ID to identify device, may also
include an information list or index associated to signals received from multiple beacons
Received signal strength metrics such as RSSI of the node providing the report
Measurement quality metrics of the Bluetooth measurements including confidence intervals,
uncertainty values, configured quality association metrics e.g., good, average bad

In another embodiment, wireless LAN (WLAN or WiFi) positioning as a RAT-independent positioning technique is enabled over SL (PC5 interface), a UE may report to another UE or group of UEs with RAT-independent positioning methods for the purposes of performing WLAN positioning in out-of-coverage scenarios (e.g., using ad-hoc WLAN connections) in addition to leveraging hybrid positioning solutions together with SL RAT-independent techniques.

In one embodiment, WLAN measurement information can be reported over SL (PC5 interface) to other UEs/SL capable devices. This can be applicable to Scenarios 1-4 as described above with reference to the first embodiment. The WLAN chipset may also be embedded within a SL capable device.

Table 11 shows the different WLAN measurement and location information elements that may be reported by SL capable devices, which are required to be reported:

TABLE 11
SL WLAN measurement location information report
SL WLAN Measurement Report

Measurement Reference Timestamp of the WLAN measurement which may include GNSS,
UTC, SFN times as a configured reference time format
WLAN applicable IDs including WLAN access point ID, SSID, pre-defined ID to identify
device/access point, may also include an information list or index associated to signals
received from multiple access points
Received signal strength metrics such as RSSI associated to the measured access points/nodes
WLAN signal RTT between the SL capable device and the WLAN access points and be
expressed in terms of different timing granularities including nanoseconds, milliseconds,
seconds, minutes, etc.
Access point channel frequency
Indication on whether the measurements are derived from a serving access point or form a
non-serving access point
Measurement quality metrics of the WLAN measurements including confidence intervals,
uncertainty values, configured quality association metrics e.g., good, average bad associated
with RSSI and RTT values indicated in the report

In one embodiment, the initiating SL capable device may transmit a reporting configuration to the responding SL capable devices to configure the responding SL-capable device to report only certain information pertaining to each of the SL RAT-independent positioning methods.

In another embodiment, an SL capable device may initiate SL RAT-independent positioning information exchange with other SL capable devices in a unicast, groupcast or broadcast (depending on Model A or Model B discovery as indicated in TS23.303, incorporated herein by reference) fashion.

FIG. 12 is an illustration of an exemplary capability information exchange procedure between two SL capable devices 1201, 1203. In response to a request (see messaging 1202), the positioning capabilities may be reported (see messaging 1204) using PC5 RRC/PC5-S/MAC CE signaling or using a dedicated PC5 positioning protocol or discovery signaling. Since the RAT-independent positioning capabilities are static in nature, this can be a one-time information exchange at any required point during a SL positioning session, e.g., at the start of a SL positioning session.

In another implementation, a UE within a group may groupcast the SL RAT-independent capability request to all or a subset of member within a group and receive the capability response message from at least one of the members within a group. In some embodiments, the discovery signaling maybe initiated and contains field to search for devices supporting SL RAT-independent capable devices supporting GPS, GNSS, sensors, Bluetooth, etc.

In another embodiment, an SL capable device may report error indications corresponding to at least one or more of the configured RAT-independent positioning methods in the event that there is a radio transmission issue with regards to the configuration and reporting of the aforementioned RAT-independent positioning techniques described above. Exemplary issues may comprise unable to receive the assistance data configuration, radio link failures resulting in retransmissions, poor link quality, multipath, non-line-of-sight (“NLOS”) links, resulting in potential error indications.

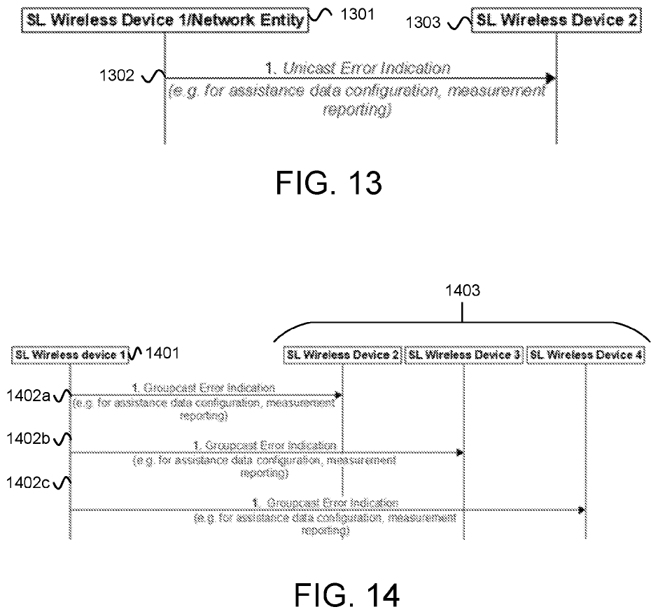

An SL capable device or network entity may report an error indication pertaining to SL configuration/assistance data and a measurement location information report. FIG. 13 and FIG. 14 are exemplary signaling illustrations of the aforementioned error indication for unicast and groupcast signaling scenarios, which may originate from a network entity as described in the above embodiments or a SL capable wireless device. In FIG. 13, a device 1301 sends an error indication (see messaging 1302) to a second device 1303. In FIG. 14, a device 1401 sends the error indication in a groupcast message (see messaging 1402a-c) to a plurality of devices 1403.

In other implementations, the error indication is not only applicable to RAT-independent positioning methods but may be equally applicable to the configuration and reporting of SL RAT-dependent positioning methods, e.g., TDoA, RTT, AoA, AOD, E-CID, or the like.

In another implementation, the node transmitting the error indication may retransmit the assistance configuration data or measurement location information report after a configured duration or based on a configured reattempt timer which may comprise of different granularities. In another implementation, the error indication may be associated and signaled with each of the RAT-independent positioning methods such as Bluetooth, Wi-Fi, or the like, and a separate error indication may be associated and signaled for the RAT-dependent positioning method.

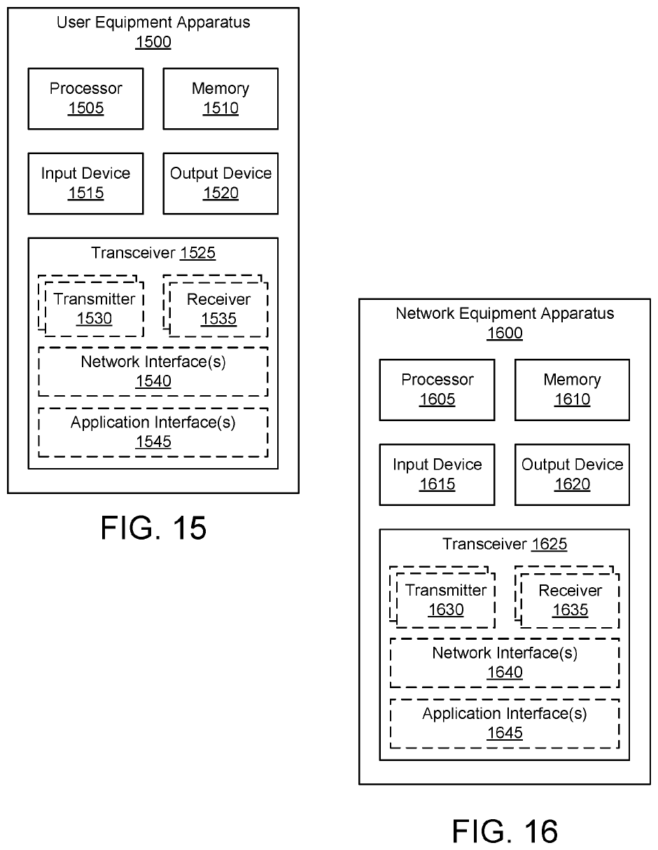

FIG. 15 depicts a user equipment apparatus 1500 that may be used for RAT-independent positioning in sidelink, according to embodiments of the disclosure. In various embodiments, the user equipment apparatus 1500 is used to implement one or more of the solutions described above. The user equipment apparatus 1500 may be one embodiment of a UE, such as the remote unit 105 and/or the UE 205, as described above. Furthermore, the user equipment apparatus 1500 may include a processor 1505, a memory 1510, an input device 1515, an output device 1520, and a transceiver 1525. In some embodiments, the input device 1515 and the output device 1520 are combined into a single device, such as a touchscreen. In certain embodiments, the user equipment apparatus 1500 may not include any input device 1515 and/or output device 1520. In various embodiments, the user equipment apparatus 1500 may include one or more of: the processor 1505, the memory 1510, and the transceiver 1525, and may not include the input device 1515 and/or the output device 1520.

As depicted, the transceiver 1525 includes at least one transmitter 1530 and at least one receiver 1535. Here, the transceiver 1525 communicates with one or more base units 121. Additionally, the transceiver 1525 may support at least one network interface 1540 and/or application interface 1545. The application interface(s) 1545 may support one or more APIs. The network interface(s) 1540 may support 3GPP reference points, such as Uu and PC5. Other network interfaces 1540 may be supported, as understood by one of ordinary skill in the art.

The processor 1505, in one embodiment, may include any known controller capable of executing computer-readable instructions and/or capable of performing logical operations. For example, the processor 1505 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 1505 executes instructions stored in the memory 1510 to perform the methods and routines described herein. The processor 1505 is communicatively coupled to the memory 1510, the input device 1515, the output device 1520, and the transceiver 1525. In certain embodiments, the processor 1505 may include an application processor (also known as “main processor”) which manages application-domain and operating system (“OS”) functions and a baseband processor (also known as “baseband radio processor”) which manages radio functions.

The memory 1510, in one embodiment, is a computer readable storage medium. In some embodiments, the memory 1510 includes volatile computer storage media. For example, the memory 1510 may include a RAM, including dynamic RAM (“DRAM”), synchronous dynamic RAM (“SDRAM”), and/or static RAM (“SRAM”). In some embodiments, the memory 1510 includes non-volatile computer storage media. For example, the memory 1510 may include a hard disk drive, a flash memory, or any other suitable non-volatile computer storage device. In some embodiments, the memory 1510 includes both volatile and non-volatile computer storage media.

In some embodiments, the memory 1510 stores data related to RAT-independent positioning in sidelink. For example, the memory 1510 may store parameters, configurations, resource assignments, policies, and the like as described above. In certain embodiments, the memory 1510 also stores program code and related data, such as an operating system or other controller algorithms operating on the user equipment apparatus 1500, and one or more software applications.

The input device 1515, in one embodiment, may include any known computer input device including a touch panel, a button, a keyboard, a stylus, a microphone, or the like. In some embodiments, the input device 1515 may be integrated with the output device 1520, for example, as a touchscreen or similar touch-sensitive display. In some embodiments, the input device 1515 includes a touchscreen such that text may be input using a virtual keyboard displayed on the touchscreen and/or by handwriting on the touchscreen. In some embodiments, the input device 1515 includes two or more different devices, such as a keyboard and a touch panel.

The output device 1520, in one embodiment, is designed to output visual, audible, and/or haptic signals. In some embodiments, the output device 1520 includes an electronically controllable display or display device capable of outputting visual data to a user. For example, the output device 1520 may include, but is not limited to, an LCD display, an LED display, an OLED display, a projector, or similar display device capable of outputting images, text, or the like to a user. As another, non-limiting, example, the output device 1520 may include a wearable display separate from, but communicatively coupled to, the rest of the user equipment apparatus 1500, such as a smart watch, smart glasses, a heads-up display, or the like. Further, the output device 1520 may be a component of a smart phone, a personal digital assistant, a television, a table computer, a notebook (laptop) computer, a personal computer, a vehicle dashboard, or the like.

In certain embodiments, the output device 1520 includes one or more speakers for producing sound. For example, the output device 1520 may produce an audible alert or notification (e.g., a beep or chime). In some embodiments, the output device 1520 includes one or more haptic devices for producing vibrations, motion, or other haptic feedback. In some embodiments, all or portions of the output device 1520 may be integrated with the input device 1515. For example, the input device 1515 and output device 1520 may form a touchscreen or similar touch-sensitive display. In other embodiments, the output device 1520 may be located near the input device 1515.

The transceiver 1525 includes at least transmitter 1530 and at least one receiver 1535. The transceiver 1525 may be used to provide UL communication signals to a base unit 121 and to receive DL communication signals from the base unit 121, as described herein. Similarly, the transceiver 1525 may be used to transmit and receive SL signals (e.g., V2X communication), as described herein. Although only one transmitter 1530 and one receiver 1535 are illustrated, the user equipment apparatus 1500 may have any suitable number of transmitters 1530 and receivers 1535. Further, the transmitter(s) 1530 and the receiver(s) 1535 may be any suitable type of transmitters and receivers. In one embodiment, the transceiver 1525 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 1525, transmitters 1530, and receivers 1535 may be implemented as physically separate components that access a shared hardware resource and/or software resource, such as for example, the network interface 1540.

In various embodiments, one or more transmitters 1530 and/or one or more receivers 1535 may be implemented and/or integrated into a single hardware component, such as a multi-transceiver chip, a system-on-a-chip, an ASIC, or other type of hardware component. In certain embodiments, one or more transmitters 1530 and/or one or more receivers 1535 may be implemented and/or integrated into a multi-chip module. In some embodiments, other components such as the network interface 1540 or other hardware components/circuits may be integrated with any number of transmitters 1530 and/or receivers 1535 into a single chip. In such embodiment, the transmitters 1530 and receivers 1535 may be logically configured as a transceiver 1525 that uses one more common control signals or as modular transmitters 1530 and receivers 1535 implemented in the same hardware chip or in a multi-chip module.

The processor 1505, in one embodiment, transmits, to at least one other device via an SL connection, a RAT-independent positioning information configuration and a RAT-independent reporting configuration. In one embodiment, the processor 1505 receives, from the at least one other device via the SL connection, a RAT-independent measurement and location report in response to the RAT-independent positioning information and reporting configuration. In one embodiment, the processor 1505 detects an error related to a SL positioning assistance data configuration, measurement, and information report. In one embodiment, the processor 1505 transmits, to the at least one other device via the SL connection, an indication of the error and a request for supported RAT-independent positioning capabilities of the at least one other device. In one embodiment, the processor 1505 receives, from the at least one other device via the SL connection, a response comprising the supported RAT-independent positioning capabilities of the at least one other device.

In one embodiment, the apparatus is embodied as at least one of base station, a roadside-unit, an anchor UE, a target-UE, or some combination thereof, and the at least one other device is embodied as at least one of a roadside-unit, an anchor UE, other UEs participating in a positioning session, or some combination thereof.

In one embodiment, the supported RAT-independent positioning capabilities for the SL positioning assistance data configuration comprises an A-GNSS, a barometric pressure sensor, or some combination thereof.

In one embodiment, the processor 1505 transmits, to the at least one other device, a location request, the location request based on a set of requirements, a set of events, or a combination thereof.

In one embodiment, the processor 1505 receives the RAT-independent positioning configuration in a solicitated manner or an unsolicited manner.

In one embodiment, the processor 1505 transmits the RAT-independent positioning configuration in a unicast manner or a groupcast manner.

In one embodiment, the processor 1505 groups the SL positioning assistance data to serve different RTK service levels as part of an SL A-GNSS RAT-independent configuration.

In one embodiment, the processor is configured to cause the apparatus to transmit barometric pressure sensor data as part of an SL barometric pressure sensor RAT-independent configuration.

In one embodiment, the RAT-independent positioning capabilities for the SL positioning reporting configuration and associated measurement and location information report may comprise an A-GNSS, a motion sensor, a WLAN, a Bluetooth device, a barometric pressure sensor, or some combination thereof.

In one embodiment, the error indication is transmitted from a network entity comprising at least one of a base station, a roadside unit, a location server, or a combination thereof in a unicast manner or a groupcast manner.

In one embodiment, the error indication is transmitted from an anchor device with a known location or another SL capable device participating in a positioning session in a unicast manner or a groupcast manner.

In one embodiment, the processor 1505 transmits and receives signals via PC5 RRC, MAC CE, PC5-S, discovery signaling, a dedicated PC5 positioning protocol, or a combination thereof.

In one embodiment, SL RAT-independent positioning capability exchange is supported for a unicast session, a groupcast session, and a broadcast session.

In one embodiment, the processor 1505 receives, from an initiator device via a SL connection, a RAT-independent positioning information configuration and a RAT-independent reporting configuration. In one embodiment, the processor 1505 transmits, to the initiator device via the SL connection, a RAT-independent measurement and location report in response to the RAT-independent positioning information and reporting configuration. In one embodiment, the processor 1505 detects an error related to a SL positioning assistance data configuration, measurement, and information report. In one embodiment, the processor 1505 transmits, to the initiator device via the SL connection, an indication of the error and a response comprising supported RAT-independent positioning capabilities of the apparatus.

FIG. 16 depicts one embodiment of a network apparatus 1600 that may be used for RAT-independent positioning in sidelink, according to embodiments of the disclosure. In some embodiments, the network apparatus 1600 may be one embodiment of a RAN node and its supporting hardware, such as the base unit 121 and/or gNB, described above. Furthermore, network apparatus 1600 may include a processor 1605, a memory 1610, an input device 1615, an output device 1620, and a transceiver 1625. In certain embodiments, the network apparatus 1600 does not include any input device 1615 and/or output device 1620.

As depicted, the transceiver 1625 includes at least one transmitter 1630 and at least one receiver 1635. Here, the transceiver 1625 communicates with one or more remote units 105. Additionally, the transceiver 1625 may support at least one network interface 1640 and/or application interface 1645. The application interface(s) 1645 may support one or more APIs. The network interface(s) 1640 may support 3GPP reference points, such as Uu, N1, N2, N3, N5, N6 and/or N7 interfaces. Other network interfaces 1640 may be supported, as understood by one of ordinary skill in the art.

The processor 1605, in one embodiment, may include any known controller capable of executing computer-readable instructions and/or capable of performing logical operations. For example, the processor 1605 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 1605 executes instructions stored in the memory 1610 to perform the methods and routines described herein. The processor 1605 is communicatively coupled to the memory 1610, the input device 1615, the output device 1620, and the transceiver 1625. In certain embodiments, the processor 1605 may include an application processor (also known as “main processor”) which manages application-domain and operating system (“OS”) functions and a baseband processor (also known as “baseband radio processor”) which manages radio function. In various embodiments, the processor 1605 controls the network apparatus 1600 to implement the above described network entity behaviors (e.g., of the gNB) for RAT-independent positioning in sidelink.

The memory 1610, in one embodiment, is a computer readable storage medium. In some embodiments, the memory 1610 includes volatile computer storage media. For example, the memory 1610 may include a RAM, including dynamic RAM (“DRAM”), synchronous dynamic RAM (“SDRAM”), and/or static RAM (“SRAM”). In some embodiments, the memory 1610 includes non-volatile computer storage media. For example, the memory 1610 may include a hard disk drive, a flash memory, or any other suitable non-volatile computer storage device. In some embodiments, the memory 1610 includes both volatile and non-volatile computer storage media.

In some embodiments, the memory 1610 stores data relating to RAT-independent positioning in sidelink. For example, the memory 1610 may store parameters, configurations, resource assignments, policies, and the like as described above. In certain embodiments, the memory 1610 also stores program code and related data, such as an operating system (“OS”) or other controller algorithms operating on the network apparatus 1600, and one or more software applications.

The input device 1615, in one embodiment, may include any known computer input device including a touch panel, a button, a keyboard, a stylus, a microphone, or the like. In some embodiments, the input device 1615 may be integrated with the output device 1620, for example, as a touchscreen or similar touch-sensitive display. In some embodiments, the input device 1615 includes a touchscreen such that text may be input using a virtual keyboard displayed on the touchscreen and/or by handwriting on the touchscreen. In some embodiments, the input device 1615 includes two or more different devices, such as a keyboard and a touch panel.

The output device 1620, in one embodiment, may include any known electronically controllable display or display device. The output device 1620 may be designed to output visual, audible, and/or haptic signals. In some embodiments, the output device 1620 includes an electronic display capable of outputting visual data to a user. Further, the output device 1620 may be a component of a smart phone, a personal digital assistant, a television, a table computer, a notebook (laptop) computer, a personal computer, a vehicle dashboard, or the like.

In certain embodiments, the output device 1620 includes one or more speakers for producing sound. For example, the output device 1620 may produce an audible alert or notification (e.g., a beep or chime). In some embodiments, the output device 1620 includes one or more haptic devices for producing vibrations, motion, or other haptic feedback. In some embodiments, all or portions of the output device 1620 may be integrated with the input device 1615. For example, the input device 1615 and output device 1620 may form a touchscreen or similar touch-sensitive display. In other embodiments, all or portions of the output device 1620 may be located near the input device 1615.

As discussed above, the transceiver 1625 may communicate with one or more remote units and/or with one or more interworking functions that provide access to one or more PLMNs. The transceiver 1625 may also communicate with one or more network functions (e.g., in the mobile core network 80). The transceiver 1625 operates under the control of the processor 1605 to transmit messages, data, and other signals and also to receive messages, data, and other signals. For example, the processor 1605 may selectively activate the transceiver (or portions thereof) at particular times in order to send and receive messages.

The transceiver 1625 may include one or more transmitters 1630 and one or more receivers 1635. In certain embodiments, the one or more transmitters 1630 and/or the one or more receivers 1635 may share transceiver hardware and/or circuitry. For example, the one or more transmitters 1630 and/or the one or more receivers 1635 may share antenna(s), antenna tuner(s), amplifier(s), filter(s), oscillator(s), mixer(s), modulator/demodulator(s), power supply, and the like. In one embodiment, the transceiver 1625 implements multiple logical transceivers using different communication protocols or protocol stacks, while using common physical hardware.

The processor 1605, in one embodiment, transmits, to at least one other device via an SL connection, a RAT-independent positioning information configuration and a RAT-independent reporting configuration. In one embodiment, the processor 1605 receives, from the at least one other device via the SL connection, a RAT-independent measurement and location report in response to the RAT-independent positioning information and reporting configuration. In one embodiment, the processor 1605 detects an error related to a SL positioning assistance data configuration, measurement, and information report. In one embodiment, the processor 1605 transmits, to the at least one other device via the SL connection, an indication of the error and a request for supported RAT-independent positioning capabilities of the at least one other device. In one embodiment, the processor 1605 receives, from the at least one other device via the SL connection, a response comprising the supported RAT-independent positioning capabilities of the at least one other device.

In one embodiment, the apparatus is embodied as at least one of base station, a roadside-unit, an anchor UE, a target-UE, or some combination thereof, and the at least one other device is embodied as at least one of a roadside-unit, an anchor UE, other UEs participating in a positioning session, or some combination thereof.

In one embodiment, the supported RAT-independent positioning capabilities for the SL positioning assistance data configuration comprises an A-GNSS, a barometric pressure sensor, or some combination thereof.

In one embodiment, the processor 1605 transmits, to the at least one other device, a location request, the location request based on a set of requirements, a set of events, or a combination thereof.

In one embodiment, the processor 1605 receives the RAT-independent positioning configuration in a solicitated manner or an unsolicited manner.

In one embodiment, the processor 1605 transmits the RAT-independent positioning configuration in a unicast manner or a groupcast manner.

In one embodiment, the processor 1605 groups the SL positioning assistance data to serve different RTK service levels as part of an SL A-GNSS RAT-independent configuration.

In one embodiment, the processor is configured to cause the apparatus to transmit barometric pressure sensor data as part of an SL barometric pressure sensor RAT-independent configuration.

In one embodiment, the RAT-independent positioning capabilities for the SL positioning reporting configuration and associated measurement and location information report may comprise an A-GNSS, a motion sensor, a WLAN, a Bluetooth device, a barometric pressure sensor, or some combination thereof.

In one embodiment, the error indication is transmitted from a network entity comprising at least one of a base station, a roadside unit, a location server, or a combination thereof in a unicast manner or a groupcast manner.

In one embodiment, the error indication is transmitted from an anchor device with a known location or another SL capable device participating in a positioning session in a unicast manner or a groupcast manner.

In one embodiment, the processor 1605 transmits and receives signals via PC5 RRC, MAC CE, PC5-S, discovery signaling, a dedicated PC5 positioning protocol, or a combination thereof.

In one embodiment, SL RAT-independent positioning capability exchange is supported for a unicast session, a groupcast session, and a broadcast session.

In one embodiment, the processor 1605 receives, from an initiator device via a SL connection, a RAT-independent positioning information configuration and a RAT-independent reporting configuration. In one embodiment, the processor 1605 transmits, to the initiator device via the SL connection, a RAT-independent measurement and location report in response to the RAT-independent positioning information and reporting configuration. In one embodiment, the processor 1605 detects an error related to a SL positioning assistance data configuration, measurement, and information report. In one embodiment, the processor 1605 transmits, to the initiator device via the SL connection, an indication of the error and a response comprising supported RAT-independent positioning capabilities of the apparatus.

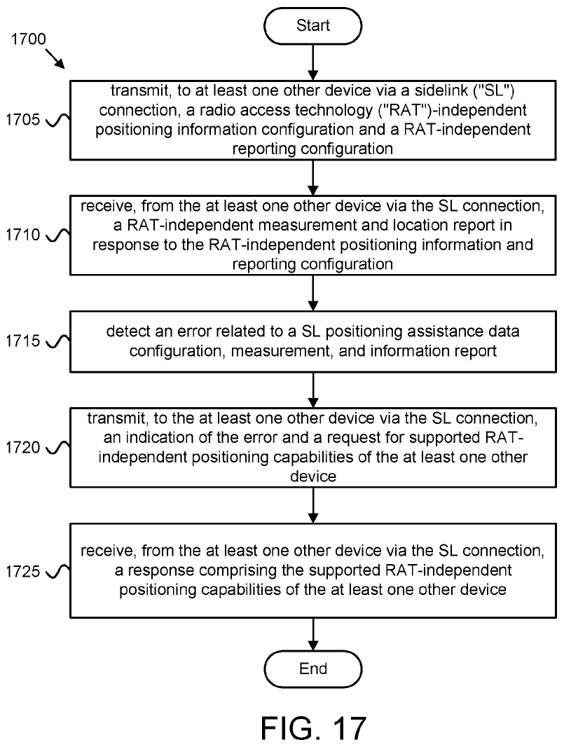

FIG. 17 is a flowchart diagram of a method 1700 for RAT-independent positioning in sidelink. The method 1700 may be performed by a UE as described herein, for example, the remote unit 105 and/or the user equipment apparatus 1500, or a network device such as a base unit 121 and/or a network equipment apparatus 1600. In some embodiments, the method 1700 may be performed by a processor executing program code, for example, a microcontroller, a microprocessor, a CPU, a GPU, an auxiliary processing unit, a FPGA, or the like.

In one embodiment, the method 1700 begins and transmits 1705, to at least one other device via an SL connection, a RAT-independent positioning information configuration and a RAT-independent reporting configuration. In one embodiment, the method 1700 receives 1710, from the at least one other device via the SL connection, a RAT-independent measurement and location report in response to the RAT-independent positioning information and reporting configuration. In one embodiment, the method 1700 detects 1715 an error related to a SL positioning assistance data configuration, measurement, and information report. In one embodiment, the method 1700 transmits 1720, to the at least one other device via the SL connection, an indication of the error and a request for supported RAT-independent positioning capabilities of the at least one other device. In one embodiment, the method 1700 receives 1725, from the at least one other device via the SL connection, a response comprising the supported RAT-independent positioning capabilities of the at least one other device. The method 1700 ends.

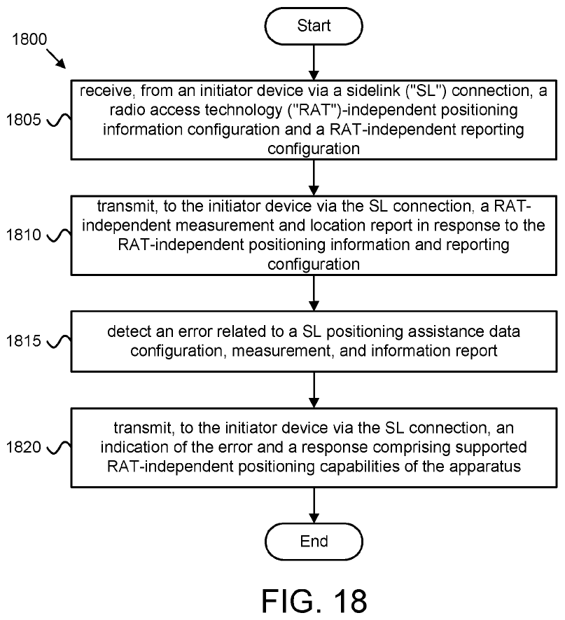

FIG. 18 is a flowchart diagram of a method 1800 for RAT-independent positioning in sidelink. The method 1800 may be performed by a UE as described herein, for example, the remote unit 105 and/or the user equipment apparatus 1500, or a network device such as a base unit 121 and/or a network equipment apparatus 1600. In some embodiments, the method 1800 may be performed by a processor executing program code, for example, a microcontroller, a microprocessor, a CPU, a GPU, an auxiliary processing unit, a FPGA, or the like.

In one embodiment, the method 1800 begins and receives 1805, from an initiator device via a SL connection, a RAT-independent positioning information configuration and a RAT-independent reporting configuration. In one embodiment, the method 1800 transmits 1810, to the initiator device via the SL connection, a RAT-independent measurement and location report in response to the RAT-independent positioning information and reporting configuration. In one embodiment, the method 1800 detects 1815 an error related to a SL positioning assistance data configuration, measurement, and information report. In one embodiment, the method 1800 transmits 1820, to the initiator device via the SL connection, an indication of the error and a response comprising supported RAT-independent positioning capabilities. The method 1800 ends.

A first apparatus is disclosed for RAT-independent positioning in sidelink. The first apparatus may include a UE as described herein, for example, the remote unit 105 and/or the user equipment apparatus 1500, or a network device such as a base unit 121 and/or a network equipment apparatus 1600. In some embodiments, the first apparatus may include a processor executing program code, for example, a microcontroller, a microprocessor, a CPU, a GPU, an auxiliary processing unit, a FPGA, or the like.

In one embodiment, the first apparatus includes a memory and a processor coupled to the memory. The processor, in one embodiment, is configured to cause the apparatus to transmit, to at least one other device via an SL connection, a RAT-independent positioning information configuration and a RAT-independent reporting configuration. In one embodiment, the processor is configured to cause the apparatus to receive, from the at least one other device via the SL connection, a RAT-independent measurement and location report in response to the RAT-independent positioning information and reporting configuration. In one embodiment, the processor is configured to cause the apparatus to detect an error related to a SL positioning assistance data configuration, measurement, and information report. In one embodiment, the processor is configured to cause the apparatus to transmit, to the at least one other device via the SL connection, an indication of the error and a request for supported RAT-independent positioning capabilities of the at least one other device. In one embodiment, the processor is configured to cause the apparatus to receive, from the at least one other device via the SL connection, a response comprising the supported RAT-independent positioning capabilities of the at least one other device.

In one embodiment, the apparatus is embodied as at least one of base station, a roadside-unit, an anchor UE, a target-UE, or some combination thereof, and the at least one other device is embodied as at least one of a roadside-unit, an anchor UE, other UEs participating in a positioning session, or some combination thereof.

In one embodiment, the supported RAT-independent positioning capabilities for the SL positioning assistance data configuration comprises an A-GNSS, a barometric pressure sensor, or some combination thereof.

In one embodiment, the supported RAT-independent positioning capabilities may comprise user equipment (“UE”)-based UE-configured positioning, UE-based network-configured positioning, UE-assisted UE-configured positioning, UE-assisted network-configured positioning, or some combination thereof.

In one embodiment, the processor is configured to cause the apparatus to transmit, to the at least one other device, a location request, the location request based on a set of requirements, a set of events, or a combination thereof.

In one embodiment, the processor is configured to cause the apparatus to receive the RAT-independent positioning configuration in a solicitated manner or an unsolicited manner.

In one embodiment, the processor is configured to cause the apparatus to transmit the RAT-independent positioning configuration in a unicast manner or a groupcast manner.

In one embodiment, the processor is configured to cause the apparatus to group the SL positioning assistance data to serve different RTK service levels as part of an SL A-GNSS RAT-independent configuration.

In one embodiment, the processor is configured to cause the apparatus to transmit barometric pressure sensor data as part of an SL barometric pressure sensor RAT-independent configuration.

In one embodiment, the RAT-independent positioning capabilities for the SL positioning reporting configuration and associated measurement and location information report may comprise an A-GNSS, a motion sensor, a WLAN, a Bluetooth device, a barometric pressure sensor, or some combination thereof.

In one embodiment, the error indication is transmitted from a network entity comprising at least one of a base station, a roadside unit, a location server, or a combination thereof in a unicast manner or a groupcast manner.

In one embodiment, the error indication is transmitted from an anchor device with a known location or another SL capable device participating in a positioning session in a unicast manner or a groupcast manner.

In one embodiment, the processor is configured to cause the apparatus to transmit and receive signals via PC5 RRC, MAC CE, PC5-S, discovery signaling, a dedicated PC5 positioning protocol, or a combination thereof.

In one embodiment, SL RAT-independent positioning capability exchange is supported for a unicast session, a groupcast session, and a broadcast session.

A first method is disclosed for RAT-independent positioning in sidelink. The first method may be performed by a UE as described herein, for example, the remote unit 105 and/or the user equipment apparatus 1500, or a network device such as a base unit 121 and/or a network equipment apparatus 1600. In some embodiments, the first method may be performed by a processor executing program code, for example, a microcontroller, a microprocessor, a CPU, a GPU, an auxiliary processing unit, a FPGA, or the like.

The first method, in one embodiment, transmits, to at least one other device via an SL connection, a RAT-independent positioning information configuration and a RAT-independent reporting configuration. In one embodiment, the first method receives, from the at least one other device via the SL connection, a RAT-independent measurement and location report in response to the RAT-independent positioning information and reporting configuration. In one embodiment, the first method detects an error related to a SL positioning assistance data configuration, measurement, and information report. In one embodiment, the first method transmits, to the at least one other device via the SL connection, an indication of the error and a request for supported RAT-independent positioning capabilities of the at least one other device. In one embodiment, the first method receives, from the at least one other device via the SL connection, a response comprising the supported RAT-independent positioning capabilities of the at least one other device.

In one embodiment, the first method is performed by a device that is embodied as at least one of base station, a roadside-unit, an anchor UE, a target-UE, or some combination thereof, and the at least one other device is embodied as at least one of a roadside-unit, an anchor UE, other UEs participating in a positioning session, or some combination thereof.

In one embodiment, the supported RAT-independent positioning capabilities for the SL positioning assistance data configuration comprises an A-GNSS, a barometric pressure sensor, or some combination thereof.

In one embodiment, the supported RAT-independent positioning capabilities may comprise user equipment (“UE”)-based UE-configured positioning, UE-based network-configured positioning, UE-assisted UE-configured positioning, UE-assisted network-configured positioning, or some combination thereof.

In one embodiment, the first method transmits, to the at least one other device, a location request, the location request based on a set of requirements, a set of events, or a combination thereof.

In one embodiment, the first method receives the RAT-independent positioning configuration in a solicitated manner or an unsolicited manner.

In one embodiment, the first method transmits the RAT-independent positioning configuration in a unicast manner or a groupcast manner.

In one embodiment, the first method groups the SL positioning assistance data to serve different RTK service levels as part of an SL A-GNSS RAT-independent configuration.

In one embodiment, the first method transmits barometric pressure sensor data as part of an SL barometric pressure sensor RAT-independent configuration.

In one embodiment, the RAT-independent positioning capabilities for the SL positioning reporting configuration and associated measurement and location information report may comprise an A-GNSS, a motion sensor, a WLAN, a Bluetooth device, a barometric pressure sensor, or some combination thereof.

In one embodiment, the error indication is transmitted from a network entity comprising at least one of a base station, a roadside unit, a location server, or a combination thereof in a unicast manner or a groupcast manner.

In one embodiment, the error indication is transmitted from an anchor device with a known location or another SL capable device participating in a positioning session in a unicast manner or a groupcast manner.

In one embodiment, the first method transmits and receives signals via PC5 RRC, MAC CE, PC5-S, discovery signaling, a dedicated PC5 positioning protocol, or a combination thereof.

In one embodiment, SL RAT-independent positioning capability exchange is supported for a unicast session, a groupcast session, and a broadcast session.

A second apparatus is disclosed for RAT-independent positioning in sidelink. The second apparatus may include a UE as described herein, for example, the remote unit 105 and/or the user equipment apparatus 1500, or a network device such as a base unit 121 and/or a network equipment apparatus 1600. In some embodiments, the second apparatus may include a processor executing program code, for example, a microcontroller, a microprocessor, a CPU, a GPU, an auxiliary processing unit, a FPGA, or the like.

In one embodiment, a second apparatus includes a memory and a processor coupled to the memory. In one embodiment, the processor is configured to cause the apparatus to receive, from an initiator device via a SL connection, a RAT-independent positioning information configuration and a RAT-independent reporting configuration. In one embodiment, the processor is configured to cause the apparatus to transmit, to the initiator device via the SL connection, a RAT-independent measurement and location report in response to the RAT-independent positioning information and reporting configuration. In one embodiment, the processor is configured to cause the apparatus to detect an error related to a SL positioning assistance data configuration, measurement, and information report. In one embodiment, the processor is configured to cause the apparatus to transmit, to the initiator device via the SL connection, an indication of the error and a response comprising supported RAT-independent positioning capabilities of the apparatus.

A second method is disclosed for RAT-independent positioning in sidelink. The second method may be performed by a UE as described herein, for example, the remote unit 105 and/or the user equipment apparatus 1500, or a network device such as a base unit 121 and/or a network equipment apparatus 1600. In some embodiments, the second method may be performed by a processor executing program code, for example, a microcontroller, a microprocessor, a CPU, a GPU, an auxiliary processing unit, a FPGA, or the like.

In one embodiment, the second method receives, from an initiator device via a SL connection, a RAT-independent positioning information configuration and a RAT-independent reporting configuration. In one embodiment, the second method transmits, to the initiator device via the SL connection, a RAT-independent measurement and location report in response to the RAT-independent positioning information and reporting configuration. In one embodiment, the second method detects an error related to a SL positioning assistance data configuration, measurement, and information report. In one embodiment, the second method transmits, to the initiator device via the SL connection, an indication of the error and a response comprising supported RAT-independent positioning capabilities.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a memory; and
a processor coupled to the memory, the processor configured to cause the apparatus to:
transmit, to at least one other device via a sidelink (“SL”) connection, a radio access technology (“RAT”)-independent positioning information configuration and a RAT-independent reporting configuration;
receive, from the at least one other device via the SL connection, a RAT-independent measurement and location report in response to the RAT-independent positioning information and reporting configuration:
detect an error related to a SL positioning assistance data configuration, measurement, and information report;
transmit, to the at least one other device via the SL connection, an indication of the error and a request for supported RAT-independent positioning capabilities of the at least one other device; and
receive, from the at least one other device via the SL connection, a response comprising the supported RAT-independent positioning capabilities of the at least one other device.

2. The apparatus of claim 1, wherein the apparatus is embodied as at least one of base station, a roadside-unit, an anchor user equipment (“UE”), a target-UE, or some combination thereof, and the at least one other device is embodied as at least one of a roadside-unit, an anchor UE, other UEs participating in a positioning session, or some combination thereof.

3. The apparatus of claim 1, wherein the supported RAT-independent positioning capabilities for the SL positioning assistance data configuration comprises an assisted global navigation satellite system (“A-GNSS”), a barometric pressure sensor, or some combination thereof.

4. The apparatus of claim 1, wherein the processor is configured to cause the apparatus to transmit, to the at least one other device, a location request, the location request based on a set of requirements, a set of events, or a combination thereof.

5. The apparatus of claim 1, wherein the processor is configured to cause the apparatus to receive the RAT-independent positioning configuration in a solicitated manner or an unsolicited manner.

6. The apparatus of claim 1, wherein the processor is configured to cause the apparatus to transmit the RAT-independent positioning configuration in a unicast manner or a groupcast manner.

7. The apparatus of claim 1, wherein the processor is configured to cause the apparatus to group the SL positioning assistance data to serve different real time kinematics (“RTK”) service levels as part of an SL assisted global navigation satellite system (“A-GNSS”) RAT-independent configuration.

8. The apparatus of claim 1, wherein the processor is configured to cause the apparatus to transmit barometric pressure sensor data as part of an SL barometric pressure sensor RAT-independent configuration.

9. The apparatus of claim 1, wherein the RAT-independent positioning capabilities for the SL positioning reporting configuration and associated measurement and location information report may comprise an assisted global navigation satellite system (“A-GNSS”), a motion sensor, a wireless local area network (“WLAN”), a Bluetooth device, a barometric pressure sensor, or some combination thereof.

10. The apparatus of claim 1, wherein the error indication is transmitted from a network entity comprising at least one of a base station, a roadside unit, a location server, or a combination thereof in a unicast manner or a groupcast manner.

11. The apparatus of claim 1, wherein the error indication is transmitted from an anchor device with a known location or another SL capable device participating in a positioning session in a unicast manner or a groupcast manner.

12. The apparatus of claim 1, wherein the processor is configured to cause the apparatus to transmit and receive signals via PC5 radio resource control (“RRC”), medium access control (“MAC”) control element (“CE”), PC5-S, discovery signaling, a dedicated PC5 positioning protocol, or a combination thereof.

13. The apparatus of claim 1, wherein SL RAT-independent positioning capability exchange is supported for a unicast session, a groupcast session, and a broadcast session.

14. A method, comprising:
transmitting, to at least one other device via a sidelink (“SL”) connection, a radio access technology (“RAT”)-independent positioning information configuration and a RAT-independent reporting configuration;
receiving, from the at least one other device via the SL connection, a RAT-independent measurement and location report in response to the RAT-independent positioning information and reporting configuration;
detecting an error related to a SL positioning assistance data configuration, measurement, and information report;
transmitting, to the at least one other device via the SL connection, an indication of the error and a request for supported RAT-independent positioning capabilities of the at least one other device; and
receiving, from the at least one other device via the SL connection, a response comprising the supported RAT-independent positioning capabilities of the at least one other device.

15. An apparatus, comprising:
a memory; and
a processor coupled to the memory, the processor configured to cause the apparatus to:
receive, from an initiator device via a sidelink (“SL”) connection, a radio access technology (“RAT”)-independent positioning information configuration and a RAT-independent reporting configuration;
transmit, to the initiator device via the SL connection, a RAT-independent measurement and location report in response to the RAT-independent positioning information and reporting configuration;
detect an error related to a SL positioning assistance data configuration, measurement, and information report; and
transmit, to the initiator device via the SL connection, an indication of the error and a response comprising supported RAT-independent positioning capabilities of the apparatus.
